(19) United States
(12) Patent Application Publication
(10) Pub. No.: US 2026/0268367 A1
(43) Pub. Date: Sep. 10, 2026

(54) DYNAMIC DISTRIBUTION AND MANAGEMENT OF RETAILER AGNOSTIC DIGITAL COUPONS

(71) Applicant: Design House, Inc., Chagrin Falls, OH (US)

(72) Inventors: Adam Zimmerman, Chagrin Falls, OH (US); David Gordon, Chagrin Falls, OH (US)

(21) Appl. No.: 19/562,555

(22) Filed: Mar. 10, 2026

Related U.S. Application Data
(60) Provisional application No. 63/769,473, filed on Mar. 10, 2025.

(51) Int. Cl. G06Q 30/0241

(52) U.S. Cl. CPC G06Q 30/0241

(57) ABSTRACT

A dynamic digital advertising content system (DDACS) for facilitating dynamic presentation, organization, and application of digital coupons is disclosed. The digital coupons are associated with a manufacturer of corresponding products. The DDACS may display a set of one or more digital coupons that are redeemable at multiple different retailer networks to obtain a discount on one or more corresponding products. Accordingly, the digital coupons are retailer agnostic. The display is formatted as a digital free standing insert that includes a grid of item cards, and each item card is associated with a corresponding digital coupon. A size and/or a position of each item card is determined as a function of vendor parameter(s) that may be determined using an artificial intelligence system. The DDACS also manages storing selected digital coupons in a digital wallet associated with a user and applying the digital coupons to purchases of corresponding products.

### CROSS REFERENCE TO RELATED APPLICATION

This application claims the benefit of U.S. Provisional Application No. 63/769,743 filed Mar. 10, 2025 the disclosure of which is hereby incorporated herein by reference in its entirety.

### TECHNICAL FIELD

The present disclosure generally relates to consumer engagement materials, and more particularly, but not exclusively, to the dynamic distribution and management of retailer agnostic digital coupons that are redeemable across multiple different retailer networks.

### BACKGROUND

The distribution and application of coupons to incentivize consumers to purchase products has traditionally been controlled by retailers. That is, a given coupon presented to a customer, such as in a newspaper, is typically redeemable only at a specific retailer or network (e.g., chain) of retailers. Accordingly, a consumer is locked into using the coupon at only a subset of retailers that are accessible to the consumer, and may be faced with the dilemma of foregoing use of a discount on a desired product or being forced to visit a retailer that is further away, offers an inferior shopping experience, or is otherwise less preferred by the consumer than another retailer where the product is sold.

Additionally, in traditional systems, it is difficult for a manufacturer of products to reliably predict and manage the effect of discounts on products produced by the manufacturer when the applicable time periods, availability, and value of the discounts (e.g., via retailer-specific coupons) differ from one retailer to the next. Accordingly, the traditional coupon distribution system, which is dictated by disparate retailers acting in their own best interests, may reduce a manufacturer’s ability to plan for and optimize manufacturing operations to enable lower margins on individual sales while making up for the lower margins with higher quantities of products sold over a known period of time.

Furthermore, through a scattershot and unfocused distribution of coupons to customers by retailers in the conventional system, consumers may expend considerable time sorting through coupons that are not pertinent to their needs and may overlook coupons that would be of benefit to them. Existing systems therefore have various shortcomings relative to certain applications. Accordingly, there remains a need for further contributions in this area of technology.

### SUMMARY

Embodiments of the present disclosure relate to a system that facilitates dynamic presentation, organization, and application of digital coupons associated with a digital free standing insert associated with a manufacturer of corresponding products. The system includes dynamic digital advertising content communications device having at least one processor, and a memory coupled with the processor. The memory includes instructions that when executed by the processor cause the processor to display, from a set of digital coupon data, a set of one or more digital coupons that are redeemable at multiple different retailer networks to obtain a discount on one or more corresponding products, wherein the display is formatted as a digital free standing insert that includes a grid of item cards. Each item card is associated with a corresponding digital coupon and at least one of a size or a position of each item card is determined as a function of one or more vendor parameters. Additionally, the processor is configured to identify, from the set of one or more displayed digital coupons from the digital free standing insert, a selected digital coupon to be stored in a digital wallet associated with a consumer. The selected digital coupon is selected based on detection of user input indicative of a selection by the consumer of the selected digital coupon from the displayed digital coupons in the digital free standing insert. The processor is also configured to store, in response to identification of the selected digital coupon and in response to a determination that a consumer account of the consumer has been registered in association with a dynamic digital content advertising content system, data indicative of the selected digital coupon in the digital wallet. Additionally, the processor is configured to present a set of one or more stored digital coupons, including the selected digital coupon, stored in association with the digital wallet of the consumer, available to be applied in connection with a purchase of a corresponding product from a retailer of the multiple different retailer networks. The processor is also configured to facilitate application of a target digital coupon from the presented set of one or more stored digital coupons to the purchase of the corresponding product in response to a selection, by the consumer, of the target digital coupon from the presented set of one or more stored digital coupons.

In an embodiment, a method may be implemented for facilitating dynamic presentation, organization, and application of digital coupons associated with a digital free standing insert associated with a manufacturer of corresponding products. The method includes displaying, with an electronic display device and from a set of digital coupon data, a set of one or more digital coupons that are redeemable at multiple different retailer networks to obtain a discount on one or more corresponding products. The display is formatted as a digital free standing insert that includes a grid of item cards and each item card is associated with a corresponding digital coupon. At least one of a size or a position of each item card is determined as a function of one or more vendor parameters. Further, the method includes identifying, from the set of one or more displayed digital coupons from the digital free standing insert, a selected digital coupon to be stored in a digital wallet associated with a consumer. The selected digital coupon is selected based on detection of user input indicative of a selection by the consumer of the selected digital coupon from the displayed digital coupons in the digital free standing insert. Additionally, the method includes storing, in a data structure in a computer memory and in response to identification of the selected digital coupon and in response to a determination that a consumer account of the consumer has been registered in association with a dynamic digital content advertising content system, data indicative of the selected digital coupon in the digital wallet. The method further includes presenting, with the electronic display device, a set of one or more stored digital coupons, including the selected digital coupon, stored in association with the digital wallet of the consumer, available to be applied in connection with a purchase of a corresponding product from a retailer of the multiple different retailer networks. The method additionally includes facilitating application of a target digital coupon from the presented set of one or more stored digital coupons to the purchase of the corresponding product in response to a selection, by the consumer, of the target digital coupon from the presented set of one or more stored digital coupons.

Another embodiment of the present disclosure is a unique dynamic digital advertising content system. Other embodiments include apparatuses, systems, devices, hardware, methods, and combinations for generation of digital free standing inserts of retailer-agnostic digital coupons and/or dynamically viewing the same. Further embodiments, forms, features, aspects, benefits, and advantages of the present application shall become apparent from the description and figures provided herewith.

### BRIEF DESCRIPTION OF THE FIGURES

FIG. 1 illustrates aspects of an embodiment of a dynamic digital advertising content system (DDACS) that may be used for distribution and management of retailer-agnostic digital coupons.

FIG. 2 illustrates a dynamic digital advertising content system that can accommodate interactions between a user, a product manufacturer/client, and one or more other parties that may participate in the application and processing of digital coupons to the sale of corresponding products.

FIG. 3 depicts an example of a consumer device being used in the selection of a digital media ad for a product and being routed to a website having an associated digital free standing insert formatted as a set of cards displaying digital coupons for products from the manufacturer.

FIG. 4 illustrates a user interface that may be presented by a consumer device to identify a consumer registered to utilize the DDACS.

FIG. 5 illustrates a user interface that may be presented by a consumer device to register a consumer to utilize the DDACS.

FIG. 6 illustrates a user interface that may be presented by a consumer device to display digital coupons that have been stored in association with a digital wallet of a consumer.

FIG. 7 illustrates a user interface that may be presented by a consumer device to display a target digital coupon selected by a consumer from the digital wallet to be applied to a purchase of a corresponding product.

FIG. 8 illustrates a user interface that may be presented by a consumer device to display digital coupons associated with a digital wallet of a consumer to indicate that at least one of the digital coupons has been used in connection with a purchase of a corresponding product.

FIGS. 9-12 are flowcharts of a method that may be performed by the DDACS to dynamically distribute and manage retailer-agnostic digital coupons.

### DETAILED DESCRIPTION OF THE ILLUSTRATIVE EMBODIMENTS

Embodiments of the disclosure generally relate to enabling a consumer to view discounts offered by a manufacturer of products (also referred to herein as a consumer package good company (CPG)) in the form of digital coupons in a digital free standing insert (i.e., a collection or arrangement of the digital coupons). The digital free standing insert is generated at least in part based on information stored in a back end system 70 system. The digital free standing insert, in one form, is based on spatial positioning and dynamic content dynamically selected to visually organize and display a plurality of content items (i.e., text, graphics, animations, and the like) representing corresponding digital coupons. Further, the embodiments of the disclosure relate to enabling the consumer to store selected (e.g., clipped) digital coupons from the digital free standing insert in a digital wallet (e.g., a database) of the consumer, such as in connection with a consumer account registered with the system, and selectively apply one or more of the digital coupons at a retailer chosen by the consumer, rather than being limited to using the digital coupon(s) with a particular retailer responsible for producing and disseminating the digital coupon(s). In an example embodiment, the digital free standing insert is displayed on a system having at least one processor and a memory coupled with the processor, the memory including instructions that cause the processor to display digital coupons redeemable at multiple different retailer networks, identify a selected digital coupon to be stored in the digital wallet, present a set of digital coupons stored in connection with the digital wallet, and facilitate application of one or more digital coupons from the digital wallet to a corresponding purchase of the associated product(s) from a retailer selected by the consumer. Such a system capable of dynamically displaying and managing digital coupons that are redeemable at multiple different retailers or retailer networks, rather than being limited to a single retailer or retailer network, greatly enhance the ability of the consumer to identify, obtain, and apply discounts offered by the manufacturer on products that the consumer is interested in.

A back end system 70 system complements the front end system 68 system and likewise includes at least one processor and a memory coupled with the processor, the memory including instructions that cause the processor to process content related to digital free standing inserts based on content uploaded by a client (e.g., a manufacturer) and/or retrieved and/or formed by the back end system 70 based upon a client request. The content can relate to the products to be displayed by the front end system 68 and associated content. The back end system 70 may be further configured to manage registration of consumer accounts, store digital coupon data in association with digital wallets of consumers, and facilitate the processing and settlement of product purchases subject to discounts from the digital coupons.

Various functions of and interactions between the front end system 68 and the back end system 70 are contemplated, including those related to various other entities/engines/networks. To set forth just a few non-limiting examples, third-party providers of services such as loyalty programs can interact with the back end system 70 to facilitate tracking and possible redemption of loyalty points with respect to purchases by the user. In some embodiments the various entities/engines/networks can exist separate from the front end system 68 and/or back end system 70, but in some forms can be integrated therewith. Continuing with a few other examples, the back end system 70 can include a portal through which a client (e.g. a manufacturer) uploads configuration information used by the back end system 70 to determine the layout of a digital free standing insert. The back end system 70 can also include and/or be integrated with a personalization AI engine useful to ingest purchase history of a user to provide a customized digital free standing insert. Various other entities/engines/networks are described in greater detail further below.

In the Detailed Description herein, references to “one embodiment”, an “embodiment”, and “example embodiment”, etc., indicate that the embodiment described may include a particular feature, structure, or characteristic, by every embodiment may not necessarily include the particular feature, structure, or characteristic. Moreover, such phrases are not necessarily referring to the same embodiment. Further, when a particular feature, structure, or characteristic may be described in connection with an embodiment, it may be submitted that it may be within the knowledge of one skilled in art to affect such feature, structure, or characteristic in connection with other embodiments whether or not explicitly described.

The following Detailed Description refers to the accompanying drawings that illustrate exemplary embodiments. Other embodiments are possible, and modifications can be made to the embodiments within the spirit and scope of this description. Those skilled in the art with access to the teachings provided herein will recognize additional modifications, applications, and embodiments within the scope thereof and additional fields in which embodiments would be of significant utility. Therefore, the Detailed Description is not meant to limit the embodiments described below.

### System Overview

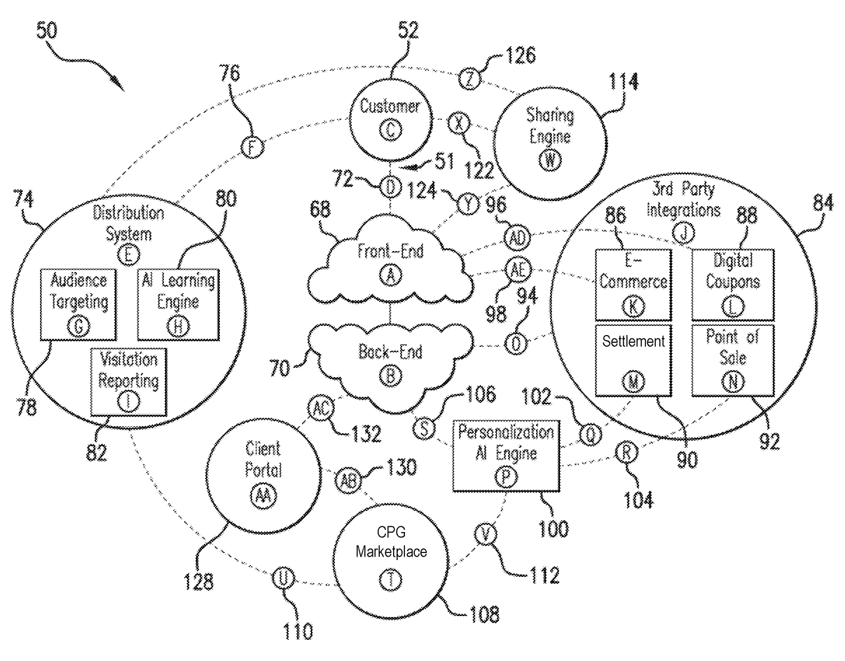

FIG. 1 illustrates aspects of an embodiment of a dynamic digital advertising content system (“DDACS”) 50, including a relationship between a user 52 and a manufacturer/client. The user 52 can be any person, user, organization, and/or entity, among others, that may be interested in perusing and/or purchasing products, goods, and/or services (collectively referred to herein as “product” or “products”) that are manufactured by a the manufacturer/client, such as through one or more retailers. The manufacturer/client can be an entity such as a business or organization, that manufactures product(s) for sale under one or more brands. As used herein, the term “manufacturer” or “client” can be used interchangeably as the terms can refer to a business or other organization engaged in the business of manufacturing products to be sold to the user 52. As also discussed below, the DDACS 50 can also be operable to accommodate communications and engagement with/by third party participants other than the user 52 and manufacturer, including, for example, third party participants such as loyalty program providers, retailers, and/or others.

The DDACS 50 is adapted to accommodate generation, distribution, application, and other management of a set of digital coupons for products produced by the manufacturer. In the illustrative embodiment, the DDACS 50 organizes the digital coupons in a digital free standing insert that is customizable based on preferences or priorities of the manufacturer and/or interests of the consumers to whom the digital coupons are to be presented. That is, and as discussed below, the DDACS 50 can be dynamic in at least terms of the arrangement and/or presentation of information, including product content, in the digital free standing insert in response to manufacturer and/or user 52 decisions and/or selections. Such engagement with the DDACS 50 by a user 52, manufacturer, and/or third party, including via the inputting of information and/or responses in/to the DDACS 50, can occur via use of a digital advertising content communications device, including via use of user interfaces provide by, or communicatively coupled to, digital advertising content communications devices. Moreover, a manufacturer, consumer 52, and/or third party can engage with the DDACS 50 via use of a variety of different types of digital advertising content communications devices, including personal computing devices, such as a desktop computer, laptop, tablet, smart phone, and/or mobile or cellular device, among other computing devices.

According to certain embodiments, the DDACS 50 includes at least a front end system 68 and a back end system 70. The front end system 68 can include instructions for the display of product content and/or manufacturer information, among other information, on a user interface of a computing device. Moreover, as discussed below in more detail, the front end system 68 can be utilized to generate and/or transmit information in the form of a digital free standing insert for presentation on the computing device of the user 52, and/or for engagement with the user 52. For example, according to certain embodiments, the front end system 68, or the back end system 70, can generate a digital free standing insert in which information regarding products, also referred to as product content, among other information, can be arranged and/or presented for display on the personal computing device of the user 52. Additionally, the front end system 68 can receive inputs, such as, for example, selections, made by the user 52 via a user interface or input device of the personal computing device, including, for example, via a touch screen, keypad, and/or mouse, among others. According to certain embodiments, the front end system 68 is, or includes, a graphical user interface of a website that permits interaction by a user 52 with content published by the manufacturer via the DDACS 50.

In at least some instances, communications between the user 52, and moreover a computing device of the user 52, and the front end system 68 can occur via a channel 72. According to certain embodiments, the channel 72 can accommodate information from the front end system 68 being provided to the user 52 in the form of an on-line content, such as, for example, in the form of a website and/or software application (“app.”) that is accessible by the consumer 52, and which permits consumer interaction with content published by the manufacturer through the DDACS 50. As will be appreciated, the website utilized with/for the channel 72 can be rendered either on the front end system 68 or back end system 70, and in some forms can use isomorphic rendering with a render on the back end system 70 first and on the front end system 68 thereafter.

The channel 72 can be configured to accommodate communication between a computing device of a user 52 and the front end system 68 using any suitable type of wired and/or wireless connection, as well as via any suitable type of communication protocol, telecommunications hardware, and associated software. Thus, the connection 72 can be, but is not limited to, an internet enabled communication, a wireless connection (e.g., Wi-Fi, Bluetooth and, cellular, etc.), or a wireline connection (e.g., utilizing infrastructure delivering telecommunications to residences and or buildings). In short, any suitable digital medium through which a computing device of the user 52 can interact with the front end system 68 and view content related to the digital free standing inserts described herein is contemplated. The computing devices of users 52 may also interact with the DDACS 50 via a manufacturer’s native software application, a downloaded Progressive Web App (PWA), or via a manufacturer’s website, including, but not limited to, a webpage or link to the DDACS 50 that is embedded directly on the manufacturer’s website.

The back end system 70 can generally be configured to accommodate input and/or content from a specific, or individual, manufacturer with respect to products that can be presented in the digital free standing insert. According to certain embodiments, the back end system 70 is a web-based software platform that can provide content management access for manufacturer websites, including, for example, content management to be performed by the manufacturer(s) and/or third parties. Further, the back end system 70 can be utilized for prioritizing the products that are to be presented in the digital free standing insert, and/or the timing or duration at which specific products can be presented in the digital free standing insert, among other features. According to certain embodiments, a client portal 128 can be provided that provides manufacturers access to the back end system 70 via a channel 132. Such a portal 128 can, for example, be a web-based software platform that is accessible to a manufacturer or other operator via a computing device.

The connection 132 between the client portal 128 and the back end system 70 can provide direct control over content management within the back end system 70. Thus, each manufacturer can have manufacturer specific credentials that can allow the manufacturer to at least access the back end system 70, and which may be utilized to access other features of the system 50, including the below-discussed marketplace 108. Accordingly, access to the back end system 70 via the client portal 128 can also involve satisfaction of certain security measures, such as, for example, a password and/or two factor authentication. Additionally, permissions can be enabled to provide users of the back end system 70 control over different areas of the associated website for that particular manufacturer, including control over portions of the website that may be accessible to customers 52 via the front end system 68.

Manufacturers can, via the client portal 128 and associated channel 132, provide or otherwise input a variety of information regarding a plurality of products to the back end system 70. Thus, for example, according to certain embodiments, the back end system 70 can comprise a database, data store, or other storage means. The manner in which product information can be provided, stored, edited, and/or removed by a manufacturer to/from the back end system 70 can vary. For example, according to certain embodiments, the back end system 70 can maintain a listing, such as, for example, a spreadsheet or table, among other manners of recording information regarding products. It will be appreciated that other types of data encapsulation and transfer to the back end system 70 are contemplated, such as, but not limited to serialization of the data and transfer via API calls. Additionally, or alternatively, individual manufacturers can, via use of the client portal 128, upload information to the back end system 70, such as, for example, upload a spreadsheet file containing text and artwork, among other product content, for one or more products. Further, data can be uploaded to the back end system 70 in a variety of other, or additional, manners, including, but not limited to, via a dynamic connection between the back end system 70 and one or more databases of the manufacturer(s), including, but not limited to, back office software, point of sales used by retailers of products from the manufacturer(s), and/or e-commerce systems, among other measures of data storage, as well as combinations thereof. Such a configuration can accommodate an uploading of relatively large amounts of information by the manufacturer to the back end system 70. Further, the back end system 70 can also include nodes that can accommodate an uploading of product content that can be shared by different business units, each of which may be associated with a brand and/or category of products, of a common parent organization or entity.

Accordingly, the back end system 70 can be utilized to archive and organize data related to a digital free standing insert, including, for example, information related to product, value/pricing, promotional start and stop dates, among other data.

In at least some embodiments, information can be provided or uploaded to the back end system 70 in the form of a spreadsheet or table. As discussed above, information can be provided to the back end system 70 in a variety of other manners as well, including, but not limited to, via a dynamic connection. A spreadsheet used for such purposes may include either rows or columns that correspond to product(s), and the other of the rows or columns can relate to characteristics, features, and/or sales for the products. For example, each row in the spreadsheet may correspond to a different product (e.g. Product #1, Product #2, etc.), and the columns of the spreadsheet may correspond to features or characteristics relating to the product and/or the sale of the product. Thus, in such an example, for each product, there may be one or product descriptor categories, one or more product sales categories, and/or one or more product display categories.

Product descriptor categories may include, but are not limited to, an indication of a category to which the product can be grouped (e.g. meat, candy, dairy, cleaning supply, pastry, beverage, etc.), brand name, product size, and/or product quantities, among other characteristics or features of the product. With respect to at least the category to which the product can be grouped, group options available for selection when entering a particular product into the table can be predetermined.

The one or more product sales categories can include, for example, the sale price of the product, product discount or rebate information, and start and end dates for a sale of the product is to be available for display in a digital free standing insert that is to be generated by the DDACS 50.

The one or more product display categories can include an indication, or location, of the artwork that is to be used, if any, for the particular product in a digital free standing insert, a size within a grid of the digital free standing insert that the information regarding the product, including artwork, is to occupy, and whether the product is to be hidden with at least a first level of the digital free standing insert. According to certain embodiments, the product display categories can also include dates and/or time durations that the particular product is to be, or can be, displayed in the digital free standing insert. The artwork for each product can correspond to a static image, animation, and/or video that can be stored by the back end system 70 and/or accessible or retrievable from a third party service. Examples of animations can include a looping animation. Animations shown for associated products in the digital free standing insert can play automatically when the user 52 scrolls to a location within the digital free standing insert at which the product is shown in the display of the user computing device. It will be appreciated that animations can include not only moving images, but also relevant product details such as product name and/or price, among other information. In some forms the animation may run in the background while relevant product details remain in the foreground. To enable the animation, a user such as the manufacturer can upload the animation to the back end system 70, or the back end system 70 can be configured to extract a looped animation from a larger video. For example, according to certain embodiments, the artwork can correspond to a link to a video that is accessible via use of the YouTube^{TM} Data application programming interface (API).

Additionally, as discussed below, the information from one or more of the product descriptor categories, product sales categories, and/or product display categories, as well as information provided by those categories can be utilized to prioritize which product content is to be displayed in the digital free standing insert, and/or assist in the ordering and positioning of content for different products in a grid of the digital free standing insert.

According to certain embodiments, the DDACS 50 can also include a CPG marketplace 108. The CPG marketplace 108 can be configured to assist manufacturers (CPG’s) with placement of digital media and digital media campaigns in the front end system 68, including with respect to placement in the digital free standing insert(s). Moreover, the CPG marketplace 108 can provide a web-based portal that can be directly accessed by manufacturers or advertising partners, so that those entities can initiate a media buy within the front end system 68 and/or in a distribution system 74. The web-based portal of the CPG marketplace 108 can also be used to communicate the details of the product content that such entities would like to publish, as well as be used to upload related artwork that may be utilized by the back end system 70. According to certain embodiments, the client portal can be connected to the CPG marketplace 108 via a connection 130 that can enable manufacturers access to the CPG marketplace 108 using their client portal credentials. Manufacturers may have third parties manage their advertising partners content and provide access by creating a new user in their client portal.

The CPG marketplace 108 can also utilize media filters, which can include personality profiles of potential users within the media space, and in particular in the digital free standing insert, to target an audience based on input by advertising partners. In some embodiments the CPG marketplace 108 can also utilize banner filters to focus media campaigns and/or content management to specific banner(s) within a manufacturer’s purview. In addition, in some embodiments the CPG marketplace 108 can utilize location filters to focus media campaign and/or content management to a set of one or more geographic locations. Additionally, in some forms the CPG marketplace 108 can utilize reward filters in which personality profiles based on rewards (loyalty) program purchase history is utilized to target an audience based on input by advertising partners.

The distribution system 74 can be configured to drive user 52, or virtual traffic, to the on-line content provided by the front end system 68, and more specifically, to the website(s) associated with individual manufacturer(s). The distribution system 74 can be adapted to utilize a variety of different tactics or approaches to drive customers to such on-line content, including, for example, via targeted medial buys. For example, the distribution system 74 can place ads in certain, or targeted, software applications or websites. In response to consumer 52 interaction with such ads, such as via user engagement with the user interface of a computing device, the consumer 52 can be taken to the retailer specific website, and, moreover, the website for a specific, individual manufacturer.

The distribution system 74 can also be configured to interact with the consumer 52 via an information pipeline 76. For example, users 52 can interact with the distribution system 74 by engaging with certain types of online content, such as, for example, interacting with on-line advertising that may be in the form of websites, results from an on-line search, connected home devices, and/or software applications, among other online content. For example, while engaging with the distribution system 74 the user 52 may see and engage with an advertisement from/for a manufacturer, at which point the user 52 is driven through channel 72 to connect with the front end system 68.

According to certain embodiments, the distribution system 74 can also be configured to have an audience targeting system 78. The audience targeting system 78 can be adapted to selectively direct particular product information, including advertisements, to a user 52 based on, or using, information that has been obtained for that particular user 52, and which may be stored, for example, in a database of the distribution system 74 and/or the audience targeting system 78, among other databases of the DDACS 50. Target audiences can be built using the audience targeting system 78 at a given moment in time, and/or across a time span, using one or more different measures including, for example, online search history(ies), credit card usage data, and/or location data, among other information.

The distribution system 74 can also be configured to include a visitation reporting system 82. The visitation reporting system 82 can be configured to monitor, and/or record within a database of the visitation reporting system 82, information regarding interaction of users 52 with targeted digital media ads of a particular manufacturer, and moreover, a website for that particular, or individual, manufacturer or a retailer that sells products from the manufacturer. The visitation reporting system 82 can be further adapted to detect, such as, for example, via location tracking of a computing device of the user 52, a subsequent physical presence of the user 52 at a particular retailer that sells products from a particular manufacturer, such as, for example, at a brick-and-mortar retail location of a particular retailer. Information regarding the monitoring of user interaction with a particular website of a manufacturer or retailer that sells products from the manufacturer, and subsequent detection of the physical presence of the user 52 at the retailer, as indicated through the location of a computing device of the user 52 at the retailer, can be recorded in a visitation report in a database of the visitation reporting system 82, among other portions of the of the distribution system 74 and/or DDACS 50.

Data from such visitation reporting can be used for a variety of purposes and/or different types of reports. For example, such visitation reporting can permit the distribution system 74 to produce a location specific store visitation quantity, such as, for example, a total number of visits, total number of visits per user 52, and/or histograms of store visitations by hour of day, among other reporting. Information regarding visitations that is stored by the visitation reporting system 82 can also be used to determine a value associated with such visitations. For example, according to certain embodiments, the number of user visitations for customers that interacted with a corresponding website of the manufacturer or retailer that sells products from the manufacturer, as provided by the DDACS 50, can be compared with associated advertising costs incurred by the manufacturer to derive a cost per user visit report(s). Such reports can, for example, provide information regarding costs per visits during certain selected time periods. Additionally, such information can also provide a variety of other customer analytics, such as, for example, the percentage of users 52 who interact with a corresponding website that then visited the location of a retailer that sells the products of the manufacturer, that were new, repeat, and/or relatively long term absentee customers in terms of either, or both, visiting the relevant website and/or physically coming to a corresponding physical store or location.

The distribution system 74 can also include an artificial intelligence (AI) engine 80. According to certain embodiments, the AI engine 80 includes one or more machine learning models. For example, the machine learning models may include neural network. The neural network may be embodied as a set of connected units (e.g., nodes) that are connected by edges. Each node receives signals (e.g., each a numeric value) from one or more connected nodes, processes the signals, and sends a corresponding output signal to other connected nodes. In processing a set of received signals, a node applies a nonlinear function, referred to as an activation function, to the sum of the numeric values (e.g., associated with the signals) received at that node. Further, a strength of each signal at each connection may be influenced by a weight. Each weight may be iteratively adjusted to reduce a resulting error in the output of the neural network.

The activation function may be, for example, a rectified linear unit (ReLU) activation function, a logistic sigmoid function, variations thereof, such as a Gaussian error linear unit (GELU) function, or other activation functions. In some embodiments, the machine learning models may include a deep learning model, which may be embodied as a neural network having three or more layers of nodes. Further, in a deep learning model, each layer passes on a more abstract representation of data to the next layer. Doing so enables enhanced identification of patterns and relationships within a data set. The machine learning models may include a model based on a transformer architecture, with multiple layers of neural networks. In such a model, each neural network has a set of parameters that may be tuned during training. One or more additional layers that form a structure known as an attention layer may focus the model on specific portions of a data set to increase the accuracy of the model in providing a human-like understanding of the underlying data set. In some embodiments, one or more of the machine learning models may initially be configured as a foundation model. That is, one or more of the machine learning models may initially be trained on a wide range of data to establish internal representations of relationships between data. Further, the foundation model(s) may be additionally trained to focus on the specific data set associated with the target application, to adapt a general intelligence of the foundation model to the specific application. In the illustrative embodiment, the model(s) of the AI engine 80 utilize recorded and/or stored information to improve the accuracy in identifying potential users 52 and/or target audiences that may be responsive to information outputted by the distribution system 74, as well as outputted from other portions of the DDACS 50.

Moreover, improving the accuracy in identifying users 52 to which particular types of different content, including content in the form of digital free standing inserts, from the distribution system 74 and/or DDACS 50 is to be directed can improve the efficiency of the distribution system 74. Further, over time, as data relating to the users 52 is accumulated by at least portions of the distribution system 74, including, by the audience targeting system 78 and/or the visitation reporting system 82, among other portions of the DDACS 50, the one or more machine learning models of the AI engine 80 can further refine the effectiveness in the operation of the distribution system 74. Such improvements in refining the identification of target users 52 or audiences via use of a machine learning model(s) of the AI learning engine 80 can result in an improvement in the efficiency of at least the distribution system 74, including, for example, with respect to reducing the cost per user visit (as discussed above with respect to visitation reporting), improve click through rates (CTR), as well as improving other key performance indicators (KPI). In some embodiments, the machine learning models may configured as an ensemble of machine learning models, in which an output of two or more models are combined by a supervisory model that adaptively adjusts weights applied to the outputs of the underlying models as a function of their prediction accuracy over time. Certain models may be rules-based models, such as decision tree models produced through gradient boosting, in which multiple weak learners are combined to form a strong learner. In such architectures, the weak learner models are iteratively trained by adjusting weights according to an error in predictions, to continually minimize a loss function.

According to certain embodiments, the accumulated, or inputted, data or information from at least the audience targeting system 78 and/or the visitation reporting system 82 can be used by the AI engine 80, and, moreover, the machine learning model(s) provided by the AI engine 80, in connection with training and/or for machine based learning of the one or more models. For example, historical information regarding past behaviors, responses, and/or actions/inactions of users 52 when engaging/not engaging content provided via the distribution system 74, among other portions of the DDACS 50, can be used by the machine learning model(s) of the AI engine 80 in connection with a pattern analysis, as well as refinement of identified patterns. Such analysis can assist the machine learning model(s) of the AI engine 80 in developing and/or refining a model that can provide a prediction of characteristics of users 52 that may, or may not, be responsive to particular types of content presented by the distribution system 74 and/or DDACS 50. Such information can thereby assist in identifying particular users 52, or users 52 having particular characteristics, to which to target, and/or those users 52 to not target, with particular content. According to certain embodiments, the machine learning model(s) of the AI engine 80 can apply such data and information to refine the structure and/or weights within the model(s) to improve accuracy and precision. The algorithms may be based on regression algorithms, classification algorithms, Bayes classification algorithms, or others. In some embodiments, the algorithm(s) may be adapted for use with a multilayer perceptron (MLP), a restricted Boltzmann Machine (RBM), a convolution neural network (CNN), or other machine learning model architecture that will be apparent to those skilled in the relevant art(s) without departing from the spirit and scope of the disclosure.

The DDACS 50, and, more specifically, the front end system 68, can also include a sharing engine 114 that can be communicatively coupled to the distribution system 74 via a connection 126, as well as communicatively coupled to the computing device of a user 52 via a connection 122. According to certain embodiments, connections with the sharing engine 114 can be made using a tool built into a browser or software application (“app.”) that enables a special hyperlink to be sent. Such special hyperlink can be sent in a variety of manners, including in a text message, an email, or copied by the user and pasted elsewhere. Further, as represented by the connection 124 shown in FIG. 1, according to certain embodiments, the sharing engine 114 can be built directly into a user interface that is displayed on the computing device of the user, thereby providing users with relatively easy access to sharing functionality.

The sharing engine 114 can be configured to permit a user 52 to share content, such as, for example, content from or corresponding to a digital free standing insert, and in the form of a hyperlink, with another user(s) 52. The hyperlink can correspond to information provided by, or in, a digital free standing insert. Further, such sharing of content can occur using a variety of different types of electronic communication, including, for example, via a text message and/or email, among other forms of electronic communication. In at least some embodiments, if a user choses to share content with one or more other users 52, the shared hyperlink can contain special codes that can trigger a rearrangement of the visual depiction of the content on the computing device of the share recipient.

As also illustrated in FIG. 1, according to certain embodiments, the DDACS 50 can further include a third party integration system 84. The third party integration system 84 can be adapted to provide an access point for third parties to access the DDACS 50. As discussed below, such access by third parties can, for example, reduce the burden on manufacturers by allowing third parties to preform sale processing and settlement operations, the results of which are provided to the back end system 70. Such access can also allow the third parties to receive information directly or indirectly from users 52, thereby further reducing the amount of data or associated activities that manufacturers have to manage and/or track. By allowing the manufacturers to combine technical resources to streamline the management process, the third party integration system 84 can provide an improved experience for the user 52.

The third party integration system 84 can be adapted to establish one or more third party integrations. For example, the exemplary embodiment depicted in FIG. 1 has four third party integrations, namely, an electronic commerce (“e-commerce”) integration 86, a digital coupon integration 88, a settlement integration 90, and a point of sales integration 92. According to certain embodiments, all third party integrations are contemplated to communicate with the back end system 70. Alternatively, as illustrated in FIG. 1, at least certain integrations 86, 88 can, in addition to, or in lieu of, being communicatively coupled to the back end system 70, can be directly or indirectly communicatively coupled to the front end system 68, such as, for example, by communication links 94, 96, 98, while other integrations 90, 92 can be directly or indirectly communicatively coupled to the back end system 70 by other communication links 102, 104. The communication links 94, 96, 98, 102, 104 can take a variety of forms, including, for example, an API, file integration, file transfer protocol (FTP), extract, transform and load (ETL), or a dynamic connection, as well as combinations thereof, among others.

The e-commerce integration 86 can correspond to an integration of a manufacturer, retailer, and/or the DDACS 50 with a third party e-commerce provider. Such access to DDACS 50 by third party e-commerce providers, and, moreover, access provided by the e-commerce integration 86, can be configured to manage the sale and/or distribution of products produced by a given manufacturer that are purchased by a consumer 52 via e-commerce rather than through in-person transactions. For example, the e-commerce integration 86, among other portions of the DDACS 50, may enable the creation and maintenance of a virtual shopping cart during a virtual shopping session and a checkout process, in which the consumer 52 pays for the products represented in the virtual shopping card through an electronic payment method, such as with payment card information (e.g., a credit card or debit card transaction through a payment card network), a request through a peer to peer payment system (e.g., PayPal, Venmo), or the like.

The digital coupon integration 88 can be adapted to allow users 52 to view digital coupon offerings from third parties, including, but not limited to, other product manufacturers or distributors, directly within the front end system 68. Such coupons, and/or corresponding hyperlinks or other information, can be virtually clipped or otherwise stored to a virtual wallet of the user 52 within the front end system 68. The digital coupon integration 88 can also be configured to accommodate third parties offering such coupons, or other sales incentives, to personalize such coupons for certain users 52, groups of users 52, and/or target audiences. In at least some embodiments, one or more operations of the front end system 68 or the back end system 70 described herein with respect to digital free standing inserts may be performed by or facilitated by the digital coupon integration 88.

In some embodiments, the third party integrations 84 may include a loyalty program integration that can correspond to loyalty programs offered by third parties, such as, for example, programs offered by third party manufacturers or distributors, among others, whose products are sold by one or more retailers associated with the DDACS 50. According to certain embodiments, embodiments, such loyalty program integration can provide such third parties to historical information maintained by the DDACS 50, and/or maintained by the DDACS 50 for specific pre-identified retailers. Such historical information can include a purchase history of users 52 on an individual, retailer, and/or on a product basis, as well as combinations thereof. Further, the loyalty program integration can accommodate parties having appropriate access rights to information regarding loyalty program(s), such as, for example, points accrued in a loyalty program(s) and/or user 52 eligibility for pricing or other benefits based on certain achievements the user 52 has obtained through participation in the loyalty program(s).

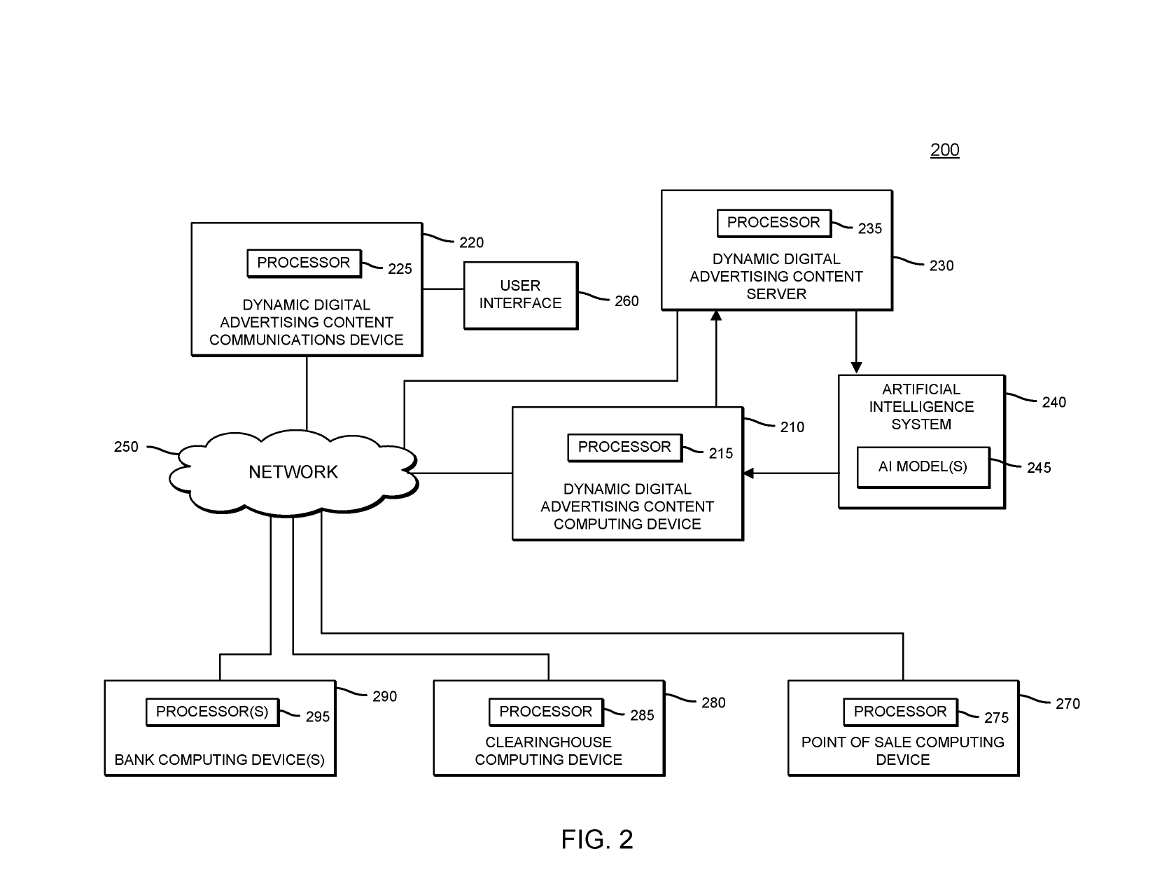

A settlement integration 90 can provide functionality to track the application of a digital coupon selected by a consumer 52 to a corresponding purchase of a product from a retailer. Further, the settlement integration 90 may enable a party to such a transaction to be reimbursed for the value of a given digital coupon. For example, in some embodiments, a customer 52 may purchase a product at full price from a retailer and receive, via the functionality of the settlement integration 90, remuneration in the form of a monetary value of the corresponding digital coupon deposited into a financial account of the consumer 52 after the purchase. In other embodiments, another party to the sales transaction, such as a retailer, may incur the cost of the digital coupon by decreasing the purchase price of the product at the time of sale. In such embodiments, the settlement integration 90 may cause the monetary value of the corresponding digital coupon to be deposited or otherwise credited to a financial account of the party (e.g., retailer) who initially bore the cost of the digital coupon. In at least some embodiments, the functionality of the settlement integration 90 may be provided by a clearinghouse system and/or one or more bank systems, described in more detail herein with respect to FIG. 2.

The point of sales integration 92 can provide visibility into store level transactions, such as the usage of particular digital coupons by consumers 52. Further, the point of sale integration 92 can provide other sales information, such as sales quantity, prices paid for products, and details regarding the particular users 52 that purchased particular products, including personal identification information and/or demographics for those users 52.

At least portions of the third party integration system 84, such as, for example, the loyalty program integration and/or the point of sales integration 92 can be communicatively coupled to a personalization artificial intelligence (AI) engine 100 of the DDACS 50. According to certain embodiments, the personalization AI engine 100 is part of the back end system 70. According to certain embodiments, the personalization AI engine 100 is a neural network that can utilize recorded and/or stored information to build personality profiles. Such personality profiles can relate to predictions relating to the types of product(s) a user 52, and/or users 52 having one or more particular types of identified characteristics, may, or may not, be likely purchase, and/or the types of advertising, discounts, and/or incentives that may, or may not, generate product sales from that/those identified user(s) 52. Further predictions generated by the a neural network of the personalization AI engine 100 may result in a reorganization, or personalization in the arrangement, of products or categories of products that are presented to the user 52 via dynamic digital advertising content, such as a digital free standing insert, that is displayed to user 52 via a corresponding computing device of the user 52. Additionally, and/or alternatively, such personalization can involve certain products being removed from, and/or certain products being added to, a current generic version of the digital free standing insert, thereby further personalizing the dynamic digital advertising content that is depicted in the digital free standing insert that is presented to the user(s) 52. The personalization attained via use of the prediction(s) from the personalization AI engine 100 can also include a generation and display of an ancillary personal webpage of that particular user 52, such as, for example, a “Just For Me” webpage, that can be displayed on the computing device of the corresponding user(s) 52. Such an ancillary personal webpage can be provided and populated with products selected based on predictions made by the neural network of the personalization AI engine 100 as to products most likely be purchased by that user 52.

According to certain embodiments, the accumulated, or inputted, data or information used by the neural network of the personalization AI engine 100 in developing a model(s) and/or identifying patterns, can include purchase history data, demographic information regarding the users 52 and the associated purchase history of those users 52, reward and/or loyalty program data or purchase history, and point of sale information. As seen in FIG. 1, at least a portion of information used to develop and refine the model(s) utilized by the neural network of the personalization AI engine 100, including in connection with self-learning, can be provided by the third party integration system 84, among other portions of the back end system 70. However, the training and/or for machine based learning of the neural network of the personalization AI engine 100 can based on, or include, a variety of other types of information, including other information maintained by, or accessible to, the DDACS 50 regarding past behaviors, responses, and/or actions/inactions of users 52. Such analysis can assist the neural network of the personalization AI engine 100 in developing and/or refining a model that can provide a prediction of characteristics of users 52 that may, or may not, be responsive to particular types of content presented in digital free standing inserts, and, moreover, a prediction of the content to presented in a digital free standing insert that can successfully facilitate sale of product(s). According to certain embodiments, the neural network of the personalization AI engine 100 can apply such data and information to one or more models, and, moreover, one or more neural network algorithms, such as, but not limited to, a multilayer perceptron (MLP), a restricted Boltzmann Machine (RBM), a convolution neural network (CNN), and/or any other neural network algorithm that will be apparent to those skilled in the relevant art(s) without departing from the spirit and scope of the disclosure. Further, in at least some embodiments, the personalization AI engine 100 may use one or more machine learning models having an architecture other than a neural network, such as a decision tree architecture developed through gradient boosting. In yet other embodiments, the personalization AI engine 100 may utilize an ensemble of machine learning models, potentially having different architectures, and that are managed by a supervisory model that selectively adjusts weights of the outputs of the underlying models in the ensemble as a function of an error in the predictions of the underlying models over time (e.g., to continually reduce the error). The description of embodiments of machine learning models associated with the AI engine 80 applies equally to the personalization AI engine 100.

A variety of different type of communication protocols can be used in connection with the connections 102, 104, 106, 112 between the personalization AI engine 100 with the third party integration system 84, the CPG marketplace 108, and the back end system 70, including, for example, API, FTP ETL, and/or dynamic connections.

The ability to dynamically interact with promotional literature, such as digital free standing inserts, can ease the shopping experience for users 52 by making shopping more appealing and efficient. Embodiments of the DDACS 50 can provide users 52 with the ability to relatively rapidly have access to up-to-date and personalized information on promotional items being offered by a manufacturer and utilize those promotional items (e.g., digital coupons) at any retailer, rather than being limited to a certain set of retailers associated with the promotional item(s). Further, the DDACS 50 may manage the storage of promotional items (e.g., digital coupons) that have been clipped (e.g., selected) by users from a digital free standing insert in a dataset (e.g., a digital wallet) that is easily accessible by a corresponding user via their account with the DDACS 50. Additionally, the DDACS 50 in combination with the third party integrations 84, in the illustrative embodiment, tracks and manages settlement of all financial transactions in which digital coupons have been applied to ensure that customers 52 and/or retailers are reimbursed (e.g., by the corresponding manufacturer) for the monetary value of the digital coupons. Moreover, these features of the DDACS 50 greatly enhance the ability of manufacturers to provide incentives to customers 52 to purchase products produced by the manufacturers, without relying on, or being subject to impediments presented by, intermediary parties such as retailers, who may otherwise control dissemination of such incentives.

While the DDACS 50 shown in FIG. 1 and discussed above has various features, not all embodiments of the DDACS 50 need include each element/capability/connection indicated by the various reference numerals of FIG. 1. Moreover, some embodiments may include fewer of the elements/capabilities/connections discussed above and indicated by the various reference numerals of FIG. 1.

### System Layout

With particular reference to the system layout 200 depicted FIG. 2, and with continued reference to FIG. 1, the DDACS 50 can use several different types of communication devices (e.g. 210, 220, 230, 270, 280, 290) connected through any suitable network 250. The system layout 200 has many similar features as that discussed above with respect to the DDACS 50; therefore, only the differences between the system layout 200 and the DDACS 50 are to be discussed in further detail immediately below.

The illustrated dynamic digital advertising content communications device 220, which can also be referred to as the user computing device 220 (or the consumer device), of a user 52 (also referred to as a consumer), includes one or more processors 225, a memory(ies), and a user interface 260. Moreover, the user computing device 220 can be similar to the digital advertising content communications devices 116 discussed above with respect to FIG. 1. The user interface 260 can comprise various types of input devices and output devices, such as, for example, a screen, display, touch screen, keyboard, and/r mouse, as well as combinations thereof, among others.

The system can also include a computing device for the manufacturer, which is identified in FIG. 2 as a dynamic digital advertising content computing device 210, and which, for purposes of discussion, can be referred to as the manufacturer computing device 210. The manufacturer computing device 210 can include one or more processors 215, a memory(ies), and a manufacturer interface. Moreover, the manufacturer computing device 210 can be similar to the types of computing devices discussed above, including, for example, the user computing device 220.

The computing devices 210, 220 are capable of interacting with each other via a network 250 and/or a dynamic digital advertising content server 230. In one form, the dynamic digital advertising content server 230 is the back end system 70 depicted in FIG. 1. The computing devices 210, 220 can thus be used to initiate and/or receive transmissions through the network 250.

As illustrated in FIG. 2, the dynamic digital advertising content server 230 can further be coupled with an artificial intelligence system 240, which, in the illustrative embodiment includes a set of one or more artificial intelligence models 245. The artificial intelligence system 240 may include at least one processor and at least one memory, similar to the devices 210, 220, 230, 270, 280, 290, and each of the artificial intelligence models 245 may be capable of being trained using input from a manufacturer or other user via the manufacturer computing device 210 and/or from information obtained from the dynamic digital advertising content server 230 (e.g. the back end system 70) to learn user 52 behaviors using information received from the digital advertising content communications device 220. According to certain embodiments, the set of artificial intelligence models 245 includes one or more of the artificial intelligence models discussed above with respect to the AI engine 80 and the personalization AI engine 100.

In at least some embodiments, the dynamic digital advertising content server 230 receives continual updates (e.g., in a stream of data) indicative of parameters that may affect the distribution and/or presentation of digital coupons associated with products produced by the manufacturer. The updates may be based on changes in user behavior, such as updates to a purchase history of one or more users, changes (e.g., from the manufacturer) to a prioritization of which product discounts should be most emphasized to users, changes to the monetary value to one or more digital coupons, changes to the media (e.g., images, animations, etc.) associated with one or more digital coupons, or the like. The received updates may define a set of vendor parameters that set out a format, including dimensions and positioning of item cards in a grid associated with a digital free standing insert. When displayed, such as on a user computing device 220, each item card may contain content indicative of a corresponding digital coupon in a digital free standing insert.

The server 230 may continuously accumulate such data and over time as the data accumulated by the content server 230 continues to increase, artificial intelligence system 240 (e.g., the previously discussed neural networks of the AI engine 80 and/or the personalization AI engine 100), may apply the data to the associated model(s) 245. In doing so, the artificial intelligence system 240 may apply the data to one or more machine learning algorithms to enable continued machine learning within the AI models 245. For example, the artificial intelligence system 240 can apply such data and information to one or more machine learning algorithms adapted for a multilayer perceptron (MLP), a restricted Boltzmann Machine (RBM), a convolution neural network (CNN), or other machine learning model architecture that will be apparent to those skilled in the relevant art(s) without departing from the spirit and scope of the disclosure.

According to certain embodiments, each time vendor parameters are streamed to the content server 230, the artificial intelligence system 240 may assist the manufacturer computing device 210 by providing the manufacturer computing device 210 with an appropriate adjustment with regard to the appropriate vendor parameters. Such an adjustment by the artificial intelligence system 240, which may be based on, for example, on the above-discussed predictions provided by the personalization AI engine 100, can accommodate each item card, and thus the associated digital free standing insert, being dynamically formatted, including formatted based on predictions provided by the personalization AI engine 100 regarding the user 52 to which the item cards will be viewed. Thus, such dynamic formatting can include the selection of which products are to be presented in the digital free standing insert, the particular content for those products that is to be presented in the item card(s) in the digital free standing insert, and/or the arrangement of the item cards in the digital free standing insert.

Again, the accuracy of the predictions of the artificial intelligence system 240, and the associated adjustments and/or selections for the formatting of the digital free standing insert, can continue to improve as the artificial intelligence system 240 further learns or is furthered trained using the continued accumulation of data that is provided from the front end system 68 and/or the back end system 70. Thus, the accuracy and/or efficiency in terms of at least product sales and/or virtual traffic resulting from the determination of the item cards that are displayed to the digital advertising content communications device 220 can be further enhanced by virtue of improving the accuracy of customization for each user 52 of the item cards that are to be displayed in the digital free standing insert on the digital advertising content communications device 220.

The artificial intelligence system 240 may assist the manufacturer computing device 210 in learning as to the display of digital free standing inserts based on the vendor parameters to push to the front end system 68 based on learned attributes of the user such that the artificial intelligence system 240 may further improve the success of any given promotion as displayed by the constantly changing digital free standing inserts that are customized and displayed for the user. For example, the artificial intelligence system 240 may receive updated vendor parameters as the user 52 engages the digital advertising content communications device 220 such as, but not limited, to internet browsing activity of the user 52. In such an example, the vendor parameters may be associated with products in a digital free standing insert that are clicked by the user 52, via the user 52 computing device 220, as the user 52 conducts the internet browsing activity. The vendor parameters, in some embodiments, may be updated in real time (e.g., as the user 52 interacts with a digital free standing insert). The artificial intelligence system 240 can be used to identify aspects of the user’s preferences through any one of many machine learning or artificial intelligence methodologies. To set forth one non-limiting example, the artificial intelligence system 240 can receive browsing activity as an input, and output product preferences. Browsing history includes such information as user 52 selections, via the communication device 220, of products of interest, number of selections, frequency of selections, time of day of selections, location of selections, etc. Such product preferences can be a category of products, a particular configuration or type of products (e.g., disposable razors vs electric razors), or the like, where such output can be pushed to a particular user’s 52 digital free standing insert. In some forms, the artificial intelligence system 240 can also output recommended time of day for pushes of product recommendations. In another non-limiting form, the artificial intelligence system 240 can receive as input browsing activity of a plurality of users 52 and the artificial intelligence system 240 can be configured to output recommended products for display tied to any one or more of the individual users.

The server 230 can include a processor, a memory, and a network interface. For example, the server 230 can include a data information system, data management system, web server, and/or file transfer server. The server 230 can also be a workstation, mobile device, computer, cluster of computers, set-top box, a cloud server or other computing device. In an embodiment, multiple modules may be implemented on the same server 230. Such a server 230 can also include software, firmware, hardware, or a combination thereof. Software may include one or more applications on an operating system. Hardware can include, but is not limited to, a processor, memory, and/or graphical user interface display.

As shown, in the layout 200, one or more point of sale computing devices 270 (e.g., part of the point of sale integration 92 of FIG. 1) may be communicatively coupled to the network 250 and in communication with other devices shown in FIG. 2. In the illustrative embodiment, each point of sale computing device 270 includes a processor 275, similar to the processors 215, 225, 235 discussed above. The point of sale computing device 270 may be located at a store (e.g., a retailer) where a user 52 purchases one or more products produced by the manufacturer. Further, one or more of the products may be subject to a digital coupon that was selected (e.g., “clipped”) by the user 52 from a digital free standing insert presented to the user 52 at an earlier time, and stored in a digital wallet associated with an account of the user (e.g., in a database of the back end system 70). At the time of sale, the user 52 may view the digital wallet using the user computing device 220, select a target digital coupon from the wallet, and apply that target digital coupon to the purchase of the product from the store. In at least some embodiments, and as discussed in more detail herein, the user computing device 220 may transmit data to the point of sale computing device 270, such as through the network 250, through a short range communication protocol (e.g. Bluetooth), through a visual identifier (e.g., a barcode, a quick response (QR) code), or through another mechanism, indicative of the digital coupon to be applied (e.g., an identifier of the digital coupon). In some embodiments, each digital coupon may have an associated identifier that is unique not only to the digital coupon itself but also to the user 52. In other embodiments, each digital coupon may have an identifier that is unique to the specific type of digital coupon (e.g., to the product, the discount to be applied, the relevant time period, etc.) but not unique to the user 52. Accordingly, in some embodiments, the point of sale computing device 270 may combine data indicative of the user 52 (e.g., based on payment card data from use of a payment card to pay for the product purchase) and data indicative of the digital coupon (e.g., the identifier of the digital coupon) to form a record of the application of the digital coupon to the purchase of the product by the user 52. The point of sale computing device 270 may transmit the record to one or more other devices associated with the DDACS 50 to enable tracking and processing of the application of the digital coupon to the purchase.

Among the devices that may receive the record from the point of sale computing device 270 or a portion thereof, is a clearinghouse computing device 280, which may form part of the settlement integration 90 shown in FIG. 1. The clearinghouse computing device 280, in the illustrative embodiment, includes a processor 285, similar to the processors 215, 225, 235, 275 discussed above. Information indicative of the financial account and corresponding bank (financial institutions) of each party involved in a transaction (e.g., a retailer, a user, a manufacturer) may be stored in a database (e.g., in the back end system 70) and accessed on an as requested basis by the clearinghouse computing device 280. In operation, the clearinghouse computing device 280 may receive data indicative of sales transactions in which digital coupons have been applied to the purchase of corresponding products and may reimburse one or more parties to those transactions. For example, in response to receipt of a record (e.g., transmitted by the point of sale computing device 270) indicating that a user 52 purchased toothpaste using a digital coupon for a $1.00 discount, the clearinghouse computing device 280 may determine which party to the transaction should be reimbursed for the monetary value of that digital coupon. For example, if the transaction indicates that the purchase price was not discounted, despite the use of the digital coupon (e.g., indicating that the user 52 paid full price), then the clearinghouse computing device 280 may transmit a request to one or more bank computing devices 290 to transfer a corresponding amount of money from a financial account of the manufacturer to a financial account of the user 52. Conversely, if the record of the transaction indicates that the user 52 paid a reduced price for the product (e.g., the full price minus the discount represented by the digital coupon), the clearinghouse computing device 280 may determine that the retailer absorbed the cost of the digital coupon for that sales transaction and may transmit a request to the one or more bank computing device 290 to transfer a corresponding amount of money from the financial account of the manufacturer to a financial account of the retailer associated with the purchase. Furthermore, the clearinghouse computing device 280 may transmit a request to the back end system 70 to update the database to indicate that the corresponding digital coupon from the digital wallet of the user 52 has been applied, and, at least in some embodiments, is no longer available for use.

Each bank computing device 290 may be associated with a corresponding financial account of a party in the system 50 (e.g., a merchant, a retailer, a user) and may be associated with a different financial institution (e.g., bank). Further, each bank computing device 290 may include a corresponding processor 295, similar to the processors 215, 225, 235, 275, 285. In operation, each bank computing device 290 may facilitate settlement of transactions associated with purchases of products subject to discounts from digital coupons, such as by initiating or accepting transfers of funds among the financial accounts, in accordance with requests from the clearinghouse computing device 280. The transfers of funds may occur through an automated clearinghouse (ACH) transfer, wire transfer, a payment card network transfer (e.g., Visa, MasterCard, American Express, Discover), a peer to peer payment system such as PayPal, Venmo, or the like.

### Retailer-Agnostic Digital Coupons

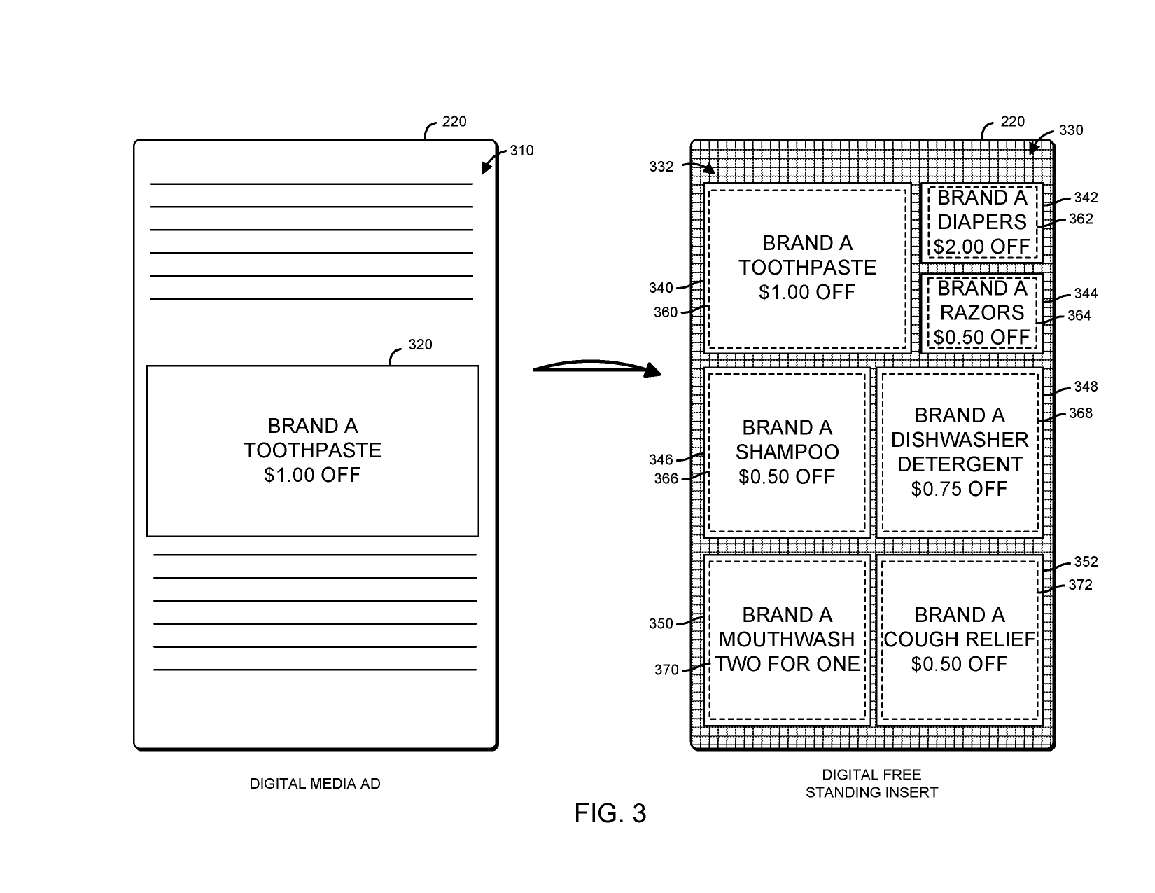

As discussed above, the DDACS 50 can be utilized to generate and display digital coupons in a digital free standing insert, that may be customized or adjusted according to a set of parameters. Referring now to FIG. 3, the user computing device 220 may display a set of content 310, such as a web page comprising text and/or images. The web page may be defined based on hypertext markup language (HTML), JavaScript, image data, and/or other components and may be rendered by a corresponding rendering engine by the user computing device 220 (e.g., in a web browser). In other embodiments, the content 310 may include user interface elements such as buttons, menus, or the like, associated with a software application executed by the user computing device 220. Regardless, as shown in FIG. 3, within the content 310, the user computing device 220 displays a digital media advertisement 320 (e.g., served by the front end system 68 of the DDACS 50). The digital media advertisement 320 in the illustrative embodiment, is associated through code (e.g., HTML, JavaScript, etc.) with a link, such as a uniform resource locator (URL) or other network address, that when selected by the user 52, causes the user computing device 220 to access, from the front end system 68, a digital free standing insert 330. The term manufacturer may be interchangeable with vendor as appreciated by one of skill in the art.

A dynamic retail media network system may generate a digital coupon circular displayed to a user via a user computing device 220 based on a plurality of vendor parameters that dynamically trigger a generation and display of a plurality of circular content items included in the digital coupon circular associated with a plurality of retailers. The manufacturing computing device 210 may provide access to a digital media coupon platform associated with the plurality of retailers in response to an end user selection of a digital coupon of a plurality of digital coupons. Each digital coupon of the plurality of coupons may be associated with each corresponding retailer and a different vendor of a plurality of vendors that vend with the retailer. The manufacturing computing device 210 may trigger the vendor parameters associated with a vendor of the selected digital coupon to determine a position of each item card of a plurality of item cards to be displayed in the digital coupon circular associated with each corresponding retailer based on the vendor parameters associated with the vendor of the selected digital coupon. The vendor parameters associated with the vendor of the selected digital coupon are indicative of a presentation of each item card as displayed in the digital coupon circular associated with each corresponding retailer and are based on a vendor priority to display the selected item card associated with the vendor of the selected digital coupon as compared to item cards not associated with the vendor of the selected digital coupon.

The manufacturing computing device 210 may dynamically generate the digital coupon circular associated with each retailer that includes the item cards created based on the vendor parameters associated with the vendor of the selected digital coupon that displays in real-time the selected item card based on the display request of the vendor of the selected digital coupon. The selected item card is displayed in real-time based on the display request of the vendor of the selected digital coupon as compared to the item cards not associated with the vendor of the selected digital coupon based on a current state of the vendor parameters. The manufacturing computing device 210 may dynamically receive updates to the vendor parameters associated with each corresponding item card that are updated in real-time based on the selections by the vendor of different item cards in the digital circular to continuously identify product preferences of the vendor. Each item card changes as the corresponding vendor parameters associated with each item card change.

The manufacturing computing device 210 may dynamically adjust the digital circular coupon grid as formatted on a display of the user computing device 220 to dynamically display updates to each item card included in the digital circular coupon grid to update an item card position and item card size of each item card and integrating the updated vendor parameters as triggered by the selections by the vendor to continuously identify product preferences of the vendor thereby triggering a change to the item card content displayed and a change in size and spatial position as each item card in the digital circular is updated. The manufacturing computing device 210 may dynamically adjust the digital circular coupon grid as formatted on the display of the user computing device 220 to prioritize the display of the selected item card in the digital coupon circular based on the updated vendor parameters. The size and spatial position of each item card is dynamically formatted to be displayed based on the content of each item card after the selected item card is dynamically formatted to be displayed based on the updated vendor parameters thereby displaying the selected item card based on the display request of the vendor of the selected digital coupon as compared to item cards not associated with the vendor of the selected digital coupon as triggered by the selections by the vendor to continuously identify the product preferences of the vendor.

The manufacturing computing device 210 may instruct the user computing device 220 to dynamically adjust the display to display updates to a digital circular coupon grid that displays each item card based on updates to a rearrangement of each item card due to a change in selection of the digital coupon received from the end user. A spatial position of each item card as displayed is dynamically adjusted as a plurality of vendor parameters associated with the change in selection of the digital coupon are updated thereby triggering the rearrangement of each item card. The manufacturing computing device may receive from the end user a first selection of a first digital coupon associated with a first vendor that is displayed on the digital media platform associated with each corresponding retailer with a second digital coupon associated with a second vendor displayed on the digital media coupon platform associated with each corresponding retailer.

The manufacturing computing device 210 may trigger a first set of vendor parameters associated with the first vendor of the selected digital coupon to determine the position of a first item card associated with the selected first digital coupon of the first vendor to be displayed in the digital coupon circular associated with each corresponding retailer based on the first set of vendor parameters associated with the first vendor. The first set of vendor parameters associated with the first vendor of the selected first digital retailer are indicative of a presentation of the first item card as displayed in the digital coupon circular of each corresponding retailer based on a first vendor priority of the first vendor to display the first item card as compared to a display of the second item card not included in the selected first digital coupon.

The manufacturing computing device 210 may generate the digital coupon circular that includes the first item card positioned based on the first vendor parameters associated with the first vendor of the selected first digital coupon that displays the first item card based on the display request of the first vendor of the first selected digital coupon and includes the second item card positioned in a secondary position as compared to the first item card. The secondary position of the second item card is determined after the first item card is positioned based on the first vendor parameters. The manufacturing computing device 210 may instruct the user computing device 220 to dynamically display the first item card in a first item card position and a first item card size to prioritize the display of the first item card as compared to the second item card that is displayed in a secondary item card position and a secondary item card size to be secondary to the first item card position and the first item card size of the first item card.

The manufacturing computing device 210 may receive from the end user a second selection of a second digital coupon associated with the second vendor that is displayed on the digital media platform associated with the retailer with the first digital coupon associated with the first vendor displayed on the digital media platform associated with each corresponding retailer. The manufacturing computing device 210 may trigger a second set of vendor parameters associated with the second vendor of the selected digital coupon to determine the position of the second item card associated with the selected second digital coupon of the second vendor to be displayed in the digital coupon circular associated with the second set of vendor parameters associated with the second vendor. The second set of vendor parameters associated with the second vendor of the selected second coupon are indicative of a presentation of the second item card as displayed in the digital coupon circular based on a second vendor priority of the second vendor to display the second item card as compared to the display of the first item card included in the first coupon. The manufacturing computing device 210 may rearrange the positioning of the second item card and the first item card based on the second vendor parameters associated with the second vendor of the selected second digital coupon based on the display request of the second vendor of the second selected digital coupon and includes the first item card positioned in the secondary position as compared to the second item card. The second item card replaces the position of the first item card and moves the first item card to the secondary position. The manufacturing computing device 210 may instruct the user computing device 220 to dynamically display the second item card in the first item card position and the first item card size to prioritize the display of the second item card as compared to the first item card that is displayed in secondary position.

The manufacturing computing device 210 may monitor each end user from a plurality of end users that selects the first digital coupon associated with the first vendor that is displayed on the digital media platform associated with the retailer via a corresponding communications device of each end user. The manufacturing computing device 210 may track each end user as each end user navigates the digital coupon circular to determine whether each end user selects the first item card positioned in the digital coupon circular based on the first vendor position provided by the first set of vendor parameters. The manufacturing computing device 210 may determine each end user that purchases a first product as advertised in the first digital coupon and displayed in the first item card of the digital coupon circular based on selecting the first digital coupon advertising the first product and selecting the first item card of the digital coupon circular displaying the first product. The manufacturing computing device 210 may provide to the first vendor a quantity of end users that purchases the first product as advertised in the first digital coupon and displayed in the first item card of the digital coupon circular based on selecting the first digital coupon advertising the first product and selecting the first item card of the digital coupon circular displaying the first product.

The manufacturing computing device 210 may monitor each end user from the plurality of end users that selects the first digital coupon associated with the first vendor that is displayed on the digital media platform associated with each corresponding retailer via the corresponding communications device of each end user. The manufacturing computing device 210 may track each end user that navigates the digital coupon circular to determine whether each end user selects the second item card positioned in the secondary position of the digital coupon circular as compared to the first item card positioned in the digital coupon circular based on the first vendor potion provided by the first set of vendor parameters. The manufacturing computing device 210 may determine each end user that purchases a second product as advertised as displayed in the second item card in the secondary position of the digital coupon circular based on selecting the first digital coupon advertising the first product and selecting the second item card of the digital circular displaying the second product in the secondary position. The manufacturing computing device 210 may provide to the second vendor a quantity of end users that purchase the second product as displayed in the second item card in the secondary position of the digital coupon circular based on selecting the first digital coupon advertising the first product and selecting the second item card of the digital circular displayed in the secondary position as compared to the first product.

The manufacturing computing device 210 may generate the digital coupon circular that includes an item card position and an item card size associated with each item card partition that each item card is to be displayed based on the vendor parameters associated with the vendor of the selected digital coupon. The selected item card that corresponds to the selected digital coupon is displayed in the item card position and the item card size that corresponds with the display request of the vendor of the selected digital coupon as compared to the item cards not associated with the vendor of the selected digital coupon. The manufacturing computing device 210 may instruct the user computing device 220 to dynamically display each item card in an item card position and an item card size associated with each item card partition to prioritize the display of the selected item card in the digital coupon circular of the retailer based on the vendor parameters. The selected item card is dynamically formatted with item card content to dynamically display the selected item card with the item card content as spatially positioned in a digital coupon circular grid to prioritize the display of the item card content of the selected item card based on the vendor parameters.

The manufacturing computing device 210 may dynamically receive updates to the digital coupon circular as each item card included in the digital coupon circular are updated based on the corresponding vendor parameters associated with each corresponding selected digital coupon in real-time. Each item card changes as the corresponding vendor parameters associated with each corresponding selected digital coupon change. The manufacturing computing device 210 may dynamically instruct the user computing device 220 to display each updated item card included in the digital coupon circular in real-time as the corresponding vendor parameters associated with each corresponding selected digital coupon change in real-time.

The manufacturing computing device 210 may dynamically receive updates to the digital coupon circular as a size associated with each item card in the digital coupon circular is adjusted based on the corresponding vendor parameters associated with each corresponding selected digital coupon are updated in real-time thereby triggering a change in size associated with each item card as the corresponding vendor parameters associated with each selected digital coupon change. The manufacturing computing device 210 may dynamically instruct the communications device to display each updated size of each updated item card included in the digital coupon circular in real-time as the corresponding vendor parameters associated with each selected digital coupon are updated in real-time triggering a change in size associated with each item card.

The digital free standing insert 330, in the illustrative embodiment, includes a grid 332 on which item cards 340, 342, 344, 346, 348, 350, 352 (e.g., containers, such as rectangles or other shapes, for displaying digital coupons) are arranged. As described above, the dimensions and positions of the item cards and corresponding digital coupons contained therein may be defined based on a set of parameters (e.g., vendor parameters) that may differ from one presentation of a digital free standing insert to another. The parameters may be adjusted as a function of user purchasing behavior tracked by the DDACS 50, changing priorities of the manufacturer to emphasize or deemphasize particular promotions (e.g., digital coupons), and/or other factors. In at least some embodiments, the parameters are set by the artificial intelligence system 240 discussed above with reference to FIG. 2. That is, the digital free standing insert can be personalized for particular user(s) 52 and repeatedly refined according to changing interests of each user 52, priorities of the manufacturer associated with the digital coupons, addition or removal of digital coupons available for use (e.g., due to passage of time and expiration of promotional offers, addition of new promotional offers, etc.), or potential improvements in user engagement determined by the artificial intelligence system 240. The personalization of a digital free standing insert 330 performed by the DDACS 50 may take the form of dynamic selection of which digital coupons will be presented in a digital free standing insert, dynamic organization, arrangement, and sizing of digital coupons (e.g., by adjusting the corresponding vendor parameters).

The user compute device 220 may cause the user interface 260 to dynamically display each item card 340, 342, 344, 346, 348, 350, 352 in an item card position and an item card size associated with each of multiple item card partitions (e.g., sets of cells of the grid 332) to prioritize the display of each item card 340, 342, 344, 346, 348, 350, 352 in the digital free standing insert 330 based on the vendor parameters. Each item card 340, 342, 344, 346, 348, 350, 352 is dynamically formatted with item card content to dynamically display each item card 340, 342, 344, 346, 348, 350, 352 with the item card content (e.g., digital coupons) spatially positioned in the grid 332 to prioritize the display of the item card content based on the vendor parameters. In at least some embodiments, the vendor parameters are additionally determined based on the available screen space of the user interface 260 of the device that is to display the item cards. For example, if an individual cell of the grid 332, when applied to the user interface 260, occupies less than a predefined number of pixels, the DDACS 50 may apply a scaling factor to the vendor parameters to enlarge the item cards within the grid 332. In doing so, a set of item cards that would otherwise be shown side by side (e.g., as a row) may be reflowed, such that they occupy multiple rows.

As shown in FIG. 3, by selecting the digital media advertisement 320 embedded in the content 310, the user 52 demonstrates an interest in a product advertised in the digital media advertisement 320 (e.g., toothpaste produced by a particular manufacturer under a particular brand, “Brand A”). The DDACS 50 may detect the identity of the user 52 based on a cookie, and internet protocol address, or other identifying data associated with the user computing device 220 and store an indication of the interest in a dataset for use in setting or adjusting vendor parameters to control which digital coupons to include in a digital free standing insert and how those digital coupons are arranged and sized. As shown in the example embodiment of FIG. 3, due to the demonstrated interest of the user 52, the DDACS 50 has placed the digital coupon 360 corresponding to the same product as the digital media advertisement 320 in an item card 340 at a prominent location in the grid 332 of the digital free standing insert 330 and has assigned a larger size to the item card 340 than the item cards 342, 344, 346, 348, 350, 352 associated with other digital coupons 362, 364, 366, 368, 370, 372 in the digital free standing insert 330. As described above, each digital coupon 360, 362, 364, 366, 368, 370, 372 is associated with a promotion by the manufacturer of the corresponding products, to incentivize consumers, such as the user 52, to purchase one or more of the products. Further, rather than being associated with a particular retailer or chain of retailers, the digital coupons 360, 362, 364, 366, 368, 370, 372 are retailer agnostic, in that the digital coupons can be applied, in the illustrative embodiment, to purchases of the products at any retailer that sells the products. To facilitate that process, in the illustrative embodiment, the user 52 may select one or more of the displayed digital coupons 360, 362, 364, 366, 368, 370, 372 to be stored in a digital wallet (e.g., a collection) associated with the user 52. Over time, the user 52 may accumulate a relatively large number of digital coupons in their digital wallet and may apply the digital coupons to purchases from any retailer, provided that the promotional period associated with the digital coupon is still active and that the user has not utilized a particular digital coupon more than a defined maximum number of times (e.g., as may be defined by the manufacturer).

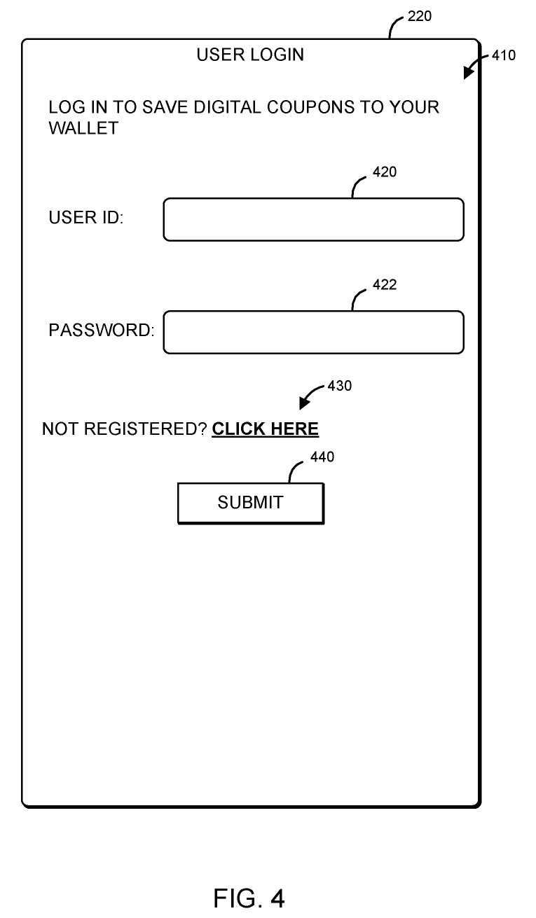

Referring now to FIG. 4, in response to detecting that the user 52 has selected a digital coupon within the digital free standing insert 330 of FIG. 3, the DDACS 50 (e.g., the user compute device 220 of the DDACS 50) may determine whether the a user account and corresponding digital wallet associated with the user 52 has been identified. If not (e.g., if the user is not logged in to the DDACS 50), the user compute device 220 may present a user login interface 410. In at least some embodiments, the user compute device 220 may present the user login interface 410 in response to an instruction from the front end system 68 to do so. Further, in at least some embodiments, the content of the user login interface 410 may be defined by instructions (e.g., HTML, JavaScript, etc.) and/or data (e.g., images) sent to the user computing device 220 from the front end system 68. The user login interface 410, in the illustrative embodiment, includes a user identification field 420 and a password field 422. Further, the user login interface 410 includes a submit button 440. Depending on the embodiment, the user 52 may enter a username, a phone number, an email address or other identifier that is unique to the user 52. The password 422 may be any string of characters, numbers, and/or symbols associated with the account of the user 52 with the DDACS 50. In response to detecting that the user 52 has selected the submit button 440, the user computing device 220, in the illustrative embodiment, sends the user identifier from the user identification field 420 and the password from the password field 422 to the front end system 68 to identify and authenticate the user 52 and to access the corresponding digital wallet of the user.

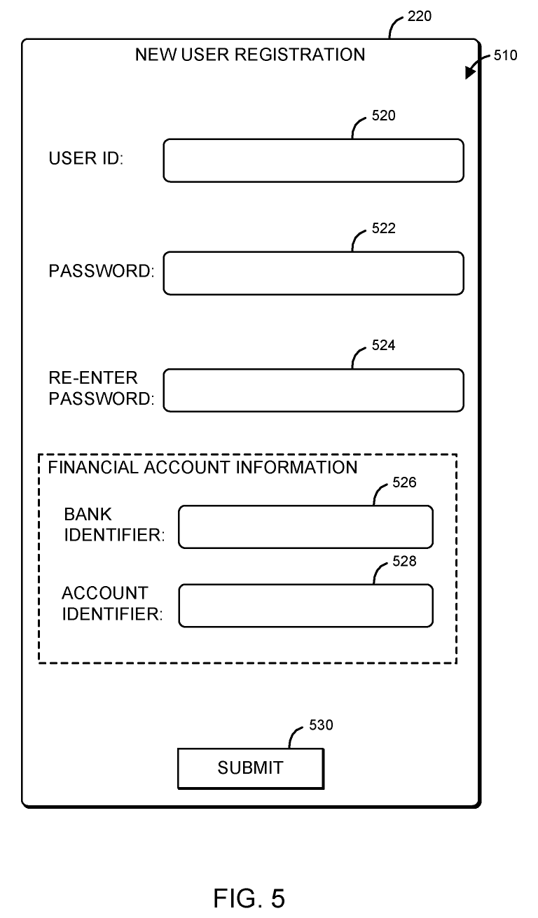

As indicated in FIG. 4, the user login interface 410 also includes a link 430 that the user 52 may select to register an account and a corresponding digital wallet with the DDACS 50. In response to detecting that the user 52 has selected the link 430, the user computing device 220 may present a user registration interface 510, an embodiment of which is shown in FIG. 5. Referring now to FIG. 5, the content of the user registration interface 510 may be defined by instructions (e.g., HTML, JavaScript, etc.) and/or data (e.g., images) sent to the user computing device 220 from the front end system 68 of the DDACS 50, such as in response to a message from the user computing device 220 that the user 52 has requested to register an account. As indicated in FIG. 5, the user registration interface 510, in the illustrative embodiment, includes a user identification field 520 similar to the user identification field 420 of the user login interface 410. Further, the user registration interface 510 includes two password fields 522, 524. In the illustrative embodiment, the user registration interface 510 includes two password fields 522, 524 to ensure that the user 52 has not accidentally mistyped the password that the user 52 wishes to adopt as their password. That is, in order for the password to be accepted and associated with the user account, the DDACS 50 (e.g., the user computing device 220) will compare the string entered into the password field 522 with the string entered into the password field 524 to determine whether they are identical. If not, the user computing device 220 may display a message indicating that the passwords entered into the two fields 522, 524 do not match.

Further, in at least some embodiments, the user registration interface 510 may include fields 526, 528 for financial account information of the user 52. The DDACS 50 may associate (e.g., in a database in the back end system 70) financial account information of the user 52 with the user account to be registered and the corresponding wallet, to facilitate tracking of purchases of products that are subject to discounts from digital coupons from the digital wallet of the user 52. That is, in at least some embodiments, the DDACS 50 or a third party integration 84 may identify purchases associated with the user 52 based on the presence of all or a portion of the financial account information in transaction records from retailers (e.g., from point of sale computing devices 270 of retailers). Further, and as described in more detail herein, the DDACS 50 or a third party integration 84 of the DDACS 50 may utilize the financial account information associated with the user account of the user 52 to transmit funds from a financial account of the manufacturer to the financial account represented in the financial account information fields 526, 528 to reimburse the user 52 after the user has applied a digital coupon from the manufacturer (e.g., stored in the digital wallet of the user) to a purchase of a corresponding product from a retailer.

In at least some embodiments, the financial account information to be provided by the user 52 includes a bank identifier, corresponding to the bank identifier field 526 and an account identifier, corresponding the to the account identifier field 528. The bank identifier may be a name, routing number, or other unique identifier of the bank associated with the financial account of the user 52. The account identifier may be any identifier, such as a string of numbers, characters, and/or symbols that uniquely identifies the account of the user 52 within a set of financial accounts managed by the bank identified in the bank identifier field 526. For example, the account identifier may be a debit account number, a credit card account number, or the like. In response to detecting that the user 52 has selected the submit button 530, the user computing device 220 may perform a validation operation to determine whether the user identifier is available. That is, the user computing device 220 may communicate with the front end system 68 and/or the back end system 70 to determine whether the user identifier has already been associated with another user. If the user identifier is not available (e.g., has already been associated with a different user account), the user computing device 220 may display a message indicating that the user should enter a different user identifier. Further, the user computing device 220 may determine whether the passwords entered in the password fields 522, 524 match, and if not, may display a message indicating that the user should reenter the password into the fields 522, 524. In some embodiments, the user computing device 220 may perform a password strength determination to determine whether the password includes a required mix of lowercase characters, uppercase characters, numbers, and/or symbols and satisfies a minimum length requirement. In such embodiments, in response to a determination that the password supplied by the user 52 does not satisfy the criteria associated with the password strength determination, the user computing device 220 may display a message indicating the requirements for the password and, in at least some embodiments, indicate which aspect of the password strength determination was not satisfied.

Similarly, the user computing device 220 may perform one or more validation operations on the financial account information. For example, the user computing device 220 may request (e.g., via an application programming interface (API) call, a representational state transfer (REST) request, or other mechanism) confirmation, from a computing device 290 of a bank identified in the bank identifier field 526, that the corresponding account identifier associated with the account identifier field 528 represents an active account that is managed by that bank. In response to a determination that the financial account information from the fields 526, 528 does not represent an active financial account managed by a corresponding bank, the user computing device 220 may prompt the user 52 to correct the financial account information. In other embodiments, the user computing device 220 may rely other computing devices of the DDACS 50 to assist in the validation operations for the information supplied by the user 52 in the user registration interface 510. For example, the user computing device 220 may send the data from each of the fields 520, 522, 524, 526, 528 to the front end system 68 or the back end system 70 and await a responsive message indicating whether one or more of the fields 520, 522, 524, 526, 528 contains deficient information. In response to a determination that the information supplied by the user 52 in the user registration interface 510 satisfies the validation operations, the DDACS 50 registers an account of the user 52 (e.g., in a database of the back end system 70). In doing so, the DDACS 50, in the illustrative embodiment, defines a digital wallet, for example as a table or other data structure in which digital coupons selected (e.g., clipped) from a digital free standing insert (e.g., the digital free standing insert 330) by the user 52 are to be stored. The digital wallet may be stored in a database of the back end system 70 and may be selectively retrieved from the back end system 70 on an as requested basis, such as when the user 52 selects an application in the memory of the user computing device 220 associated with the digital wallet. In some embodiments, the user computing device 220 may cache data associated with the digital wallet and may request, from the DDACS 50 (e.g., from the back end system 70) updates to the cached data on a scheduled basis (e.g., daily, hourly, etc.). Additionally or alternatively, the user computing device 220 may transmit a notification to the user computing device 220 when an update to the digital wallet has been made in the DDACS 50 (e.g., in response to a determination that a digital coupon has been applied to a product purchase, in response to a determination that the digital coupon has expired, or based on one or more other updates). In response, the user computing device 220 may retrieve the update from the DDACS 50 for storage in the memory of the user computing device 220.

Referring back to FIG. 3, in response to a determination that the user 52 is logged into the DDACS 50 and has selected a digital coupon 360, 362, 364, 366, 368, 370, 372, the user computing device 220, in the illustrative embodiment, transmits an update message to the DDACS 50 (e.g., to the front end system 68 and/or the back end system 70) indicating the digital coupon(s) selected by the user 52. In at least some embodiments, each digital coupon 52 has a corresponding identifier, which may be encoded as a property (e.g., as a tag in HTML, in a data structure defined in JavaScript, or otherwise, depending on the encoding scheme for the digital free standing insert 330) of the digital coupon 360, 362, 364, 366, 368, 370, 372 or the associated item card 340, 342, 344, 346 ,348, 350, 352. Accordingly, the message transmitted from the user computing device 220 may include the identifier(s) of the digital coupon(s) selected by the user 52. In response, the DDACS 50 may update the digital wallet of the user 52 to include the added (e.g., clipped) digital coupon(s).

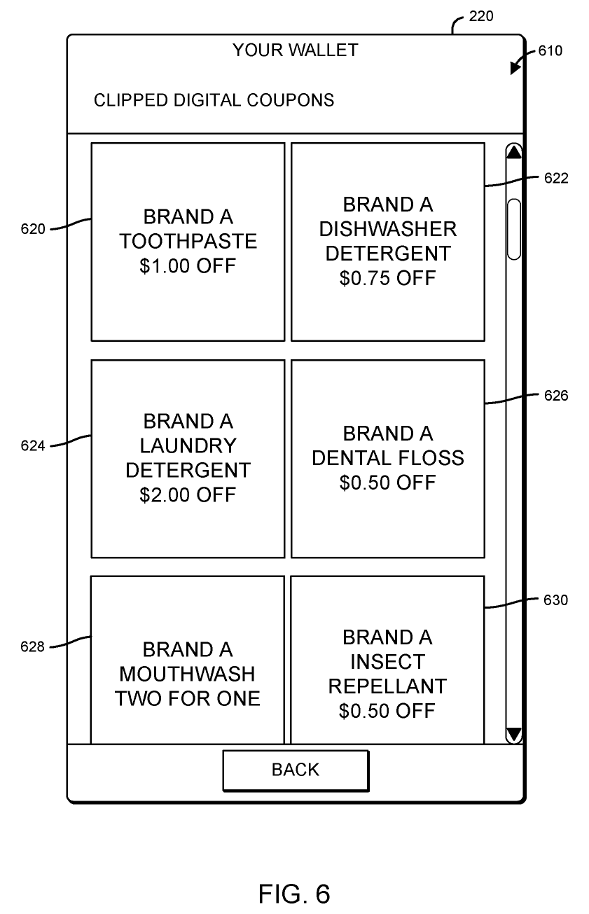

Referring now to FIG. 6, the user computing device 220 may present a user interface 610 indicative of a digital wallet of the user 52. In some embodiments, the user computing device 220 may present the user interface in response to detecting that the user 52 has selected an application stored in a memory of the user computing device 220 to display the digital wallet. Additionally or alternatively, in some embodiments, the user computing device 220 may present the user interface 610 in response to a determination that the user 52 is at or within a predefined distance of a retailer that sells products from the manufacturer associated with the digital coupon(s) in the digital wallet. The user computing device 220 may determine that the user 52 is at or within a predefined distance of such a retailer by periodically comparing a location of the user computing device 220 (e.g., based on global positioning system (GPS) signals and/or triangulation of location based on signals from towers of a cellular network) to known locations of retailers (e.g., from a database of retailers from a mapping database, such as Google Maps, HERE map data, or the like, which may be accessed via a corresponding API). In some embodiments, the user computing device 220 may detect a short range signal emitted at the retailer, such as an RFID signal, a near field communication (NFC) signal, a Bluetooth signal (e.g., Bluetooth Low Energy), or the like, such as from a beacon device located at an entrance to the retailer or at a point of sale computing device (e.g., point of sale computing device 270) of the retailer.

As shown in the user interface 610, the digital wallet includes a set of digital coupons 620, 622, 624, 626, 628, 630, clipped by the user 52 from one or more digital free standing inserts, such as the digital free standing insert 330 discussed above. As will be appreciated, the digital coupon 620 shown in FIG. 6 corresponds with the digital coupon 360 shown in FIG. 3. At the time of purchase, the user 52 may select a digital coupon within the user interface 610 to apply the digital coupon to a purchase of a corresponding product from a retailer.

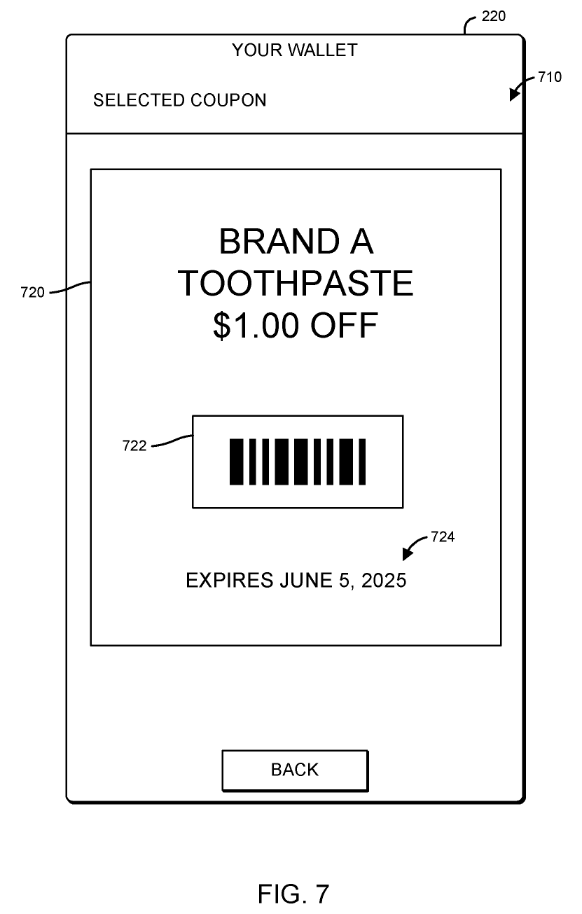

Referring to FIG. 7, in at least some embodiments, in response to determining that the user 52 has selected a digital coupon (e.g., the digital coupon 620) from the digital wallet represented in the user interface 610, the user computing device 220 may display a detailed view 710 of the digital coupon 620 with additional information, as shown in the user interface 710. In at least some embodiments, the detailed view 720 includes a visual identifier 722 associated with the digital coupon 620. The visual identifier 722 may be embodied as a linear bar code (e.g., formatted according to a corresponding standard, such as EAN-13 or UPC), a two dimensional code (e.g., a quick response (QR) code), or other symbol or set of symbols to convey data associated with the selected digital coupon (e.g., to a scanner device or a camera associated with the point of sale device). In some embodiments the visual identifier may be in a human-readable format, such as plain text. The visual identifier may represent the unique identifier of the digital coupon (e.g., the identifier referenced above in connection with the display of the digital coupons in the digital free standing insert 330). In some embodiments, the visual identifier 722 may include a combination of the identifier of the digital coupon and the user identifier associated with account of the user 52. The two sets of data (the identifier of the digital coupon and the user identifier) may, in some embodiments, be combined using a hashing function, such as SHA-256, or the like. In some embodiments, in addition to or as an alternative to displaying the visual identifier 722, the user computing device 220 may transmit the data associated with the visual identifier (e.g., the identifier of the digital coupon and/or a combination of the identifier of the digital coupon and the user identifier) to the point of sale device 270, such as through near field communication (NFC), a Bluetooth connection, or other short range communication protocol.

As shown in FIG. 7, the user interface 710 additionally indicates a time period 724 (e.g., the present time to Jun. 5, 2025) in which the digital coupon 620 is valid (e.g., available to be applied to a purchase). In some embodiments, additional or alternative data may be displayed in connection with a given digital coupon in the user interface 710, such as a number of uses or applications of the coupon remaining (e.g., if the digital coupon has a defined number of uses other than one). In some embodiments, the user may initially select multiple digital coupons from the user interface 610 of the digital wallet and, in response, the user computing device 220 may iteratively display a user interface similar to the user interface 710 for each digital coupon that was selected by the user 52 in the user interface 610. The user computing device 220 may pause on a given detailed view of a selected digital coupon for a predefined period of time (e.g., two seconds), may await a confirmation signal from the point of sale device 270, such as an audible tone from a scanning device (e.g., detected by a microphone of the user communication device 220), a wireless communication signal (e.g., via Bluetooth or other short range communication protocol), or an interaction by the user 52 (e.g., tapping or swiping on the screen (e.g., the user interface 260)) to move to the detailed view of the next selected digital coupon. By cycling through a set of selected digital coupons, the user computing device 220 may expedite the checkout process and eliminate the need for the user 52 to navigate between the digital wallet view (e.g., the user interface 610) and the detailed view (e.g., the user interface 710) for each digital coupon to be applied.

In at least some embodiments, the retailer associated with the point of sale device 270 will initially bear the cost of the discount associated with each applied digital coupon. That is, the cost of the product(s) may be decreased instantaneously as the digital coupons are applied, such that the user 52 pays a reduced price for the product(s). In other embodiments, the user 52 may pay an undiscounted price for the products at the time of the transaction. In either case, in the illustrative embodiment, the party that bore the cost of the digital coupons is reimbursed by the DDACS 50 or a third party integration 84 thereof, such as the settlement integration 90, after the transaction. For example, a clearinghouse computing device 280 may obtain a record of the transaction (e.g., directly from the point of sale computing device 270 via the network 250 or upon requesting the record from another component of the DDACS 50, such as the front end system 68 or the back end system 70). The clearinghouse computing device 280 may determine which party bore the cost of the digital coupons (e.g., by comparing an undiscounted or normal price of the product(s) to the actual price paid by the user 52, by analyzing a field in the transaction record indicative of whether discounts were applied to the purchase price paid by the user 52, and/or based on other indicia). In response to a determination that the retailer bore the cost (e.g., by discounting the price to be paid by the user 52 at the time of the transaction), the clearinghouse compute device 280 may communicate with one or more bank computing devices 290 associated with banks for the manufacturer and the retailer to initiate a transfer of funds from a financial account of the manufacturer to a financial account of the retailer, to cover the cost of the digital coupons that were applied. The financial account information associated with the retailer may be indicated in the record of the transaction, in at least some embodiments. In some embodiments, the financial account information for the retailer and/or the manufacturer may be stored in a database (e.g., the back end system 70) of the DDACS 50 and available to the clearinghouse computing device 280 upon request (via an application programming interface (API) call or other communication mechanism). Otherwise, the clearinghouse computing device 280 may perform a similar process to initiate a transfer of funds from the financial account of the manufacturer to the financial account of the user 52 (e.g., as identified in the registration data provided to the DDACS 50 during the user registration process described above with reference to FIG. 5). Accordingly, it should be understood that the clearinghouse computing device 280 may access the relevant financial account information on an as requested basis from the back end system 70 of the DDACS 50.

After a digital coupon has been applied to a product purchase, the DDACS 50 may update the digital wallet (e.g., a database of the back end system 70) to reflect that the digital coupon has been applied. For digital coupons that can be utilized more than once but not an unlimited number of times, the DDACS 50 may decrease a value indicative of a number of remaining uses of the digital coupon that are available for the corresponding user 52. In some embodiments, the DDACS 50 may update the digital wallet after settlement of the transaction involving digital coupon(s) has occurred. That is, in some embodiments, the DDACS 50 may update the digital wallet of the user 52 in response to receiving a confirmation from a corresponding bank computing device 290 that the funds have been transferred from the financial account of the manufacturer to the financial account of the party that bore the cost of the digital coupons during the transaction. In some embodiments, the DDACS 50 may receive the confirmation not directly from a bank computing device 290 but from a third party integration 84, such as from the clearinghouse computing device 280 forming at least a portion of the settlement integration 90. After the DDACS 50 has updated the digital wallet of the user 52 (e.g., in a database of the back end system 70), the DDACS 50 may send an message to the user computing device 220 indicating that the digital wallet of the user 52 has been updated and, in response, the user computing device 220 may request an updated data structure indicative of the present state of the digital wallet of the user 52. In some embodiments, rather than sending data indicative of every digital coupon in the digital wallet, the DDACS 50 may send only data indicative of the changes (the delta) from the last time the user computing device 220 received data indicative of the digital wallet. As will be appreciated by those skilled in the art, sending only the changes to the digital wallet reduces the burden on the network 250 while still ensuring that the version of the digital wallet in the memory of the user computing device 220 is up to date.

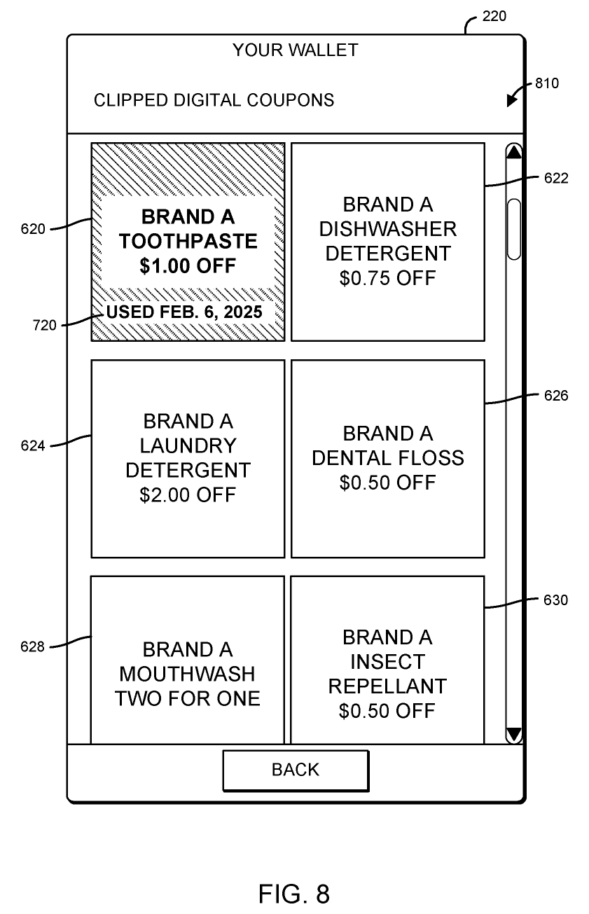

Referring now to FIG. 8, the user computing device 220 may present a user interface 810 representing an updated state of the digital wallet of the user 52. As indicated, in the user interface 810, the digital coupon 620 is greyed out indicating that the digital coupon 620 is not available for use by the user 52. Further, the user interface 810 includes a notation 724 overlaid on the digital coupon 620 indicating the reason why the digital coupon is not available for use (i.e., that the digital coupon was used on February 6, 2025). In some embodiments, the user computing device 220 may produce a sound or other indication that the digital coupon 620 is no longer available for use in response to detecting that the user 52 selected (e.g., tapped or clicked on) the digital coupon 620. In at least some embodiments, the user computing device 220 may request (e.g., from the DDACS 50, such as from the front end system 68) a new digital free standing insert, similar to the digital free standing insert 330 described above, in response to detecting that the user selected the unavailable digital coupon 620. In response, the DDACS 50 may generate an updated free standing insert with an updated set of digital coupons, positioned and sized according to updated vendor parameters (e.g., as determined by the artificial intelligence system 240).

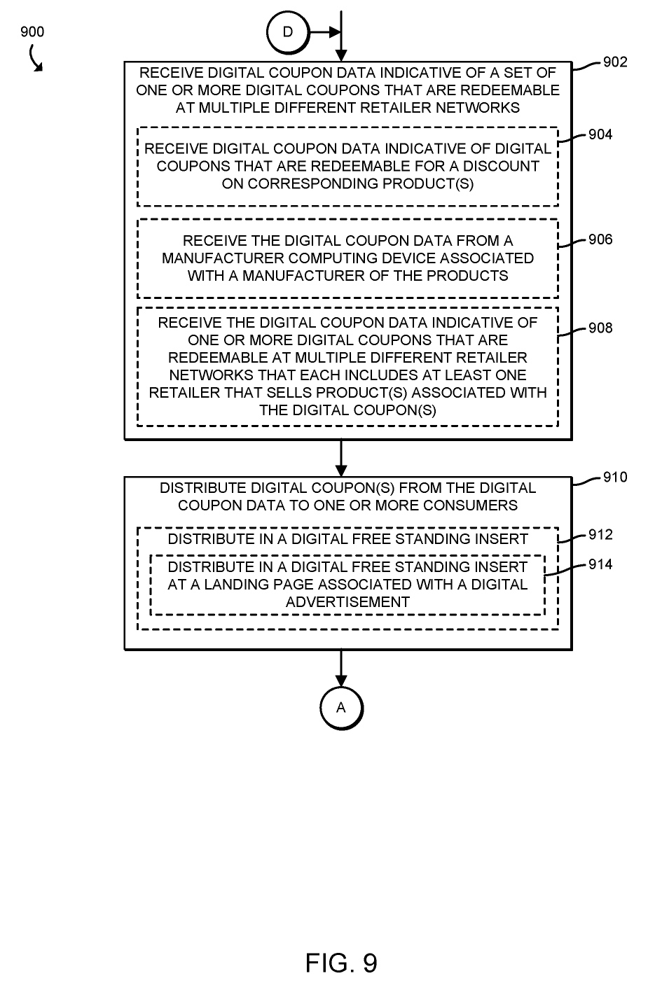

Referring now to FIG. 9, in operation, the DDACS 50 may perform a method 900 for dynamically distributing and managing retailer agnostic digital coupons. The method 900, in the illustrative embodiment, begins with block 902 in which the DDACS 50 (e.g., the front end system 68 or the back end system 70) receives digital coupon data. The digital coupon data, in the illustrative embodiment, is indicative of a set of one or more digital coupons that are redeemable at multiple different retailer networks. That is, the digital coupons can work at any of multiple retailers and, as such, are agnostic as to which retailer a user 52 would like to use the digital coupons at. As indicated in block 904, in receiving digital coupon data, the DDACS 50 (e.g., the front end system 68 or the back end system 70) may receive digital coupon data that is indicative of digital coupons that are redeemable for a discount on corresponding products. The digital coupon data may include data indicative of the monetary value (e.g., the amount of the discount), a period of time in which the digital coupon is valid, a number of permissible uses of the digital coupon per user, the product to which the digital coupon pertains, an identifier of the digital coupon, and media content to be used in connection with the digital coupon, such as text, images, animations, and/or the like. In the illustrative embodiment, the DDACS 50 may receive the digital coupon data from a manufacturer computing device (e.g., the manufacturer computing device 210, also referred to as a dynamic digital advertising content computing device) associated with a manufacturer of the products, as indicated in block 906. That is, unlike other systems, the DDACS 50 enables a manufacturer rather than retailers or retailer networks to control the creation and distribution of digital coupons to incentivize consumers to purchase their products. Accordingly, the DDACS 50 provides a more direct and unimpeded connection between the manufacturer and the consumers, allowing the manufacturer to more precisely and accurately plan for the costs associated with any incentive program (e.g., represented by digital coupons) and the changes in production that may be needed to satisfy an increased demand in products due to the incentive program. Additionally, the DDACS 50 enables consumers to utilize the digital coupons at a wider range of retailers than would otherwise be possible. Further to the point above and as indicated in block 908, the DDACS 50 may receive the digital coupon data indicative of one or more digital coupons that are redeemable at multiple different retailer networks. Each of the different retailer networks includes at least one retailer that sells one or more products associated with the digital coupons. As described above, in at least some embodiments, the DDACS 50 receives the digital coupon data from the manufacturer (e.g., from the manufacturer computing device 210, also referred to as the dynamic digital advertising content computing device) via a client portal of the CPG marketplace 108.

Continuing the method 900, the DDACS 50 distributes one or more digital coupons from the digital coupon data, received by the DDACS 50 from a manufacturer computing device 210 via the CPG marketplace 108, to one or more consumers, as indicated in block 910. In doing so, and as indicated in block 912, the DDACS 50, in the illustrative embodiment, distributes the one or more digital coupons in the form of a digital free standing insert, such as the digital free standing insert 330 represented in FIG. 3, discussed above. As described relative to FIG. 3, and as indicated in block 914, the DDACS 50 may distribute the digital coupon(s) in a digital free standing insert at a landing page (e.g., a web page) associated with a digital advertisement, such as the digital media advertisement 320 embedded in the web page content 310. In other embodiments the DDACS 50 may generate and direct a computing device (e.g., a user computing device 220) to a digital free standing insert through another path, such as in response to an application executed locally on the user compute device 220 requesting a digital free standing insert in response to a triggering event. The triggering event may be a recurring periodic trigger, such as once per day or once per week, or another interval, such as an interval set by the user 52 in a set of user preferences. Additionally or alternatively, a triggering event may be a user interaction within the locally executed application on the user computing device 220, such as a user selecting a user interface element displayed to the user 52. For example, and as described above, user computing device 220 may request a new digital free standing insert from the DDACS 50 in response to detecting that the user 52 selected a digital coupon that has been marked as unavailable (e.g., because the digital coupon has already been applied by the user 52 to product purchases a threshold number of times). In other embodiments, the locally executed application on the user computing device 220 may include a button for the user to request a new digital free standing insert and in response to detecting that the user selected the button, the user computing device 220 issues a corresponding request to the DDACS 50 for a new digital free standing insert to display to the user 52.

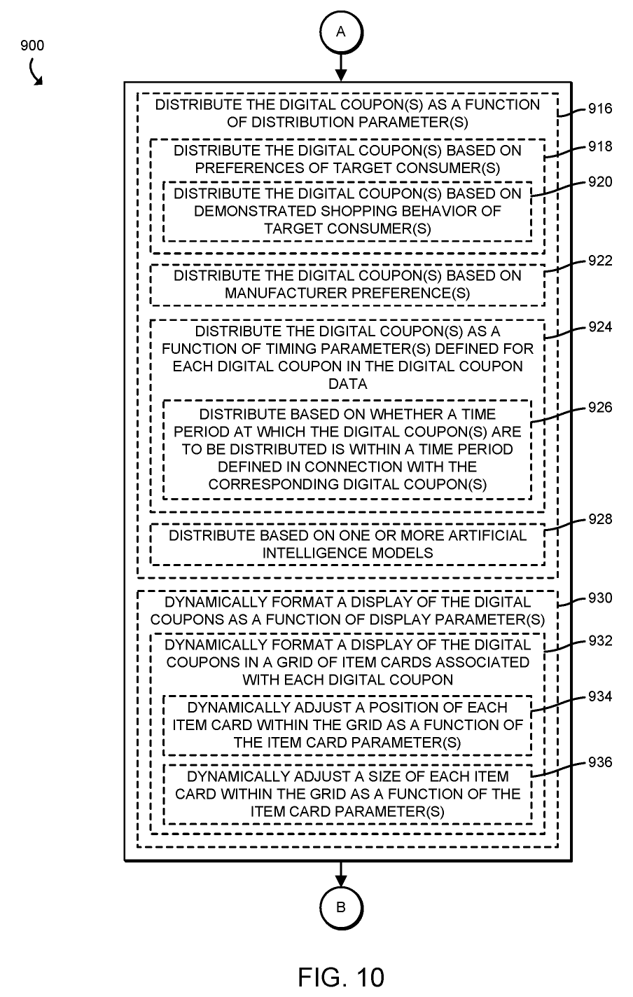

Referring now to FIG. 10, in continuing the method 900 and as part of distributing the digital coupons, the DDACS 50, in the illustrative embodiment, distributes the digital coupons as a function of (e.g., based on) a set of one or more distribution parameters (e.g., variables that influence the distribution). Those distribution parameters may include preferences of one or more target consumers. That is, in at least some embodiments, the DDACS 50 may distribute the digital coupons based on preferences of one or more target consumers (e.g., the user 52), as indicated in block 918. The preferences may be evidenced by a demonstrated shopping behavior of one or more target consumers, as indicated in block 920. The DDACS 50 may track the shopping behavior of consumers based on records of sales transactions submitted from retailer point of sale computing devices 270 in which an identifier of a corresponding consumer (e.g., user 52) or an account of a consumer is present, tracking cookies stored by a web browser (e.g., executed by the user computing device 220), data from an e-commerce integration 86, indicative of items in a virtual shopping cart of a user, and/or other sources. In some embodiments, the preferences of one or more consumers may be indicated based on a consumer (e.g., user 52) clicking on a digital media advertisement corresponding to a product sold by a manufacturer, such as in the scenario described above with reference to FIG. 3. In yet other embodiments, the preferences of consumers may be evidenced by consumers (e.g., the user 52) selecting an existing but no longer available digital coupon in a digital wallet of the user 52, as described above in the example associated with FIG. 8. In yet other embodiments, a consumer 52 may expressly indicate their preferences, such as in in a set of user settings or preferences associated with a locally executed application (e.g., on the user computing device 220) associated with the DDACS 50 (e.g., a digital wallet application).

As indicated in block 922, the DDACS 50 may distribute the digital coupons based on manufacturer preferences. The manufacturer preferences may be indicated through data submitted by a corresponding manufacturer (e.g., a manufacturer computing device 210) through the portal associated with the CPG marketplace 108. In some embodiments, the manufacturer preferences may be indicated in the digital coupon data. That is, in some embodiments, the digital coupon data may include a field indicative of a prioritization assigned by the manufacturer to the corresponding coupon. In other embodiments, the digital coupon data may identify a set of brands or products that the manufacturer wishes to emphasize the most in the distribution of digital coupons, and may include an identifier in connection with each digital coupon of which brand or product the digital coupon corresponds with. In other embodiments, data indicative of the manufacturer’s preferences with respect to which digital coupons to prioritize may be encoded or structured in another way, as will be appreciated by those skilled in the art.

As indicated in block 924, the DDACS 50 may distribute the digital coupons as a function of (e.g., based on) one or more timing parameters defined for each digital coupon in the digital coupon data. That is, and as described above, the digital coupon data, in at least some embodiments, may indicate a time period for a promotional program in which each digital coupon is valid. In other words, the digital coupon data may indicate the time period in which each digital coupon can be used in connection with a purchase of a corresponding product. As indicated in block 926, the DDACS 50 may distribute the digital coupons based on whether a time period at which the digital coupons are to be distributed is within a time period defined in connection with the corresponding digital coupons (i.e., the time period for the promotional program). As described above, distribution of the digital coupons occurs, at least in the illustrative embodiments, through digital free standing inserts, such as the digital free standing insert 330. Accordingly, in the illustrative embodiment, the DDACS 50 filters out, from preliminary set of candidate digital coupons for inclusion in a digital free standing insert, any digital coupons for which the present date (e.g., the date at which the digital free standing insert is to be transmitted to a consumer, such as for viewing on the user computing device 220) does not fall within the time period (e.g., the promotional period) associated with those digital coupons. As indicated in block 928, the DDACS 50 may distribute the digital coupons based on one or more artificial intelligence models. That is, as described above, the DDACS 50 may utilize the artificial intelligence system 240, and specifically the artificial intelligence models 245, which correspond to the artificial intelligence engine 80 and the personalization artificial intelligence engine 100, to iteratively improve the distribution of digital coupons (e.g., to maximize utilization by customers) based on continual feedback from previous distributions digital coupons through digital free standing inserts.

The DDACS 50 may dynamically format a display of the digital coupons, as indicated in block 930. In doing so, the DDACS 50 may dynamically format the display as a function of (e.g., based on) a set of display parameters (e.g., variables that influence the display of each of the digital coupons). As indicated in block 932, the DDACS 50 may dynamically format the display of the digital coupons in a grid of item cards associated with each digital coupon. An example grid with corresponding item cards is described above with reference to the grid 332 and the item cards 340, 342, 344, 346, 348, 350, 352 of FIG. 3. The DDACS 50 may dynamically adjust a position of each item card within the grid as a function of the vendor parameters, as indicated in block 934. Similarly, the DDACS 50 may dynamically adjust a size of each item card within the grid as a function of the vendor parameters, as indicated in block 936. The positions of the item cards may be encoded as coordinates within the grid, such as x and y coordinates, and the sizes may be encoded as length and width or other dimensions (e.g., radius, perimeter, etc. for non-rectangular item cards). The positions and sizes (e.g., dimensions) may be defined as properties of the item cards, such as in HTML or another encoding scheme, utilized by the front end system 68 to provide the item cards to the user computing device 220. The item card defines the dimensions for the corresponding digital coupon to be displayed within the item card. By assigning a larger size and more centralized or noticeable position (e.g., as may be determined by the artificial intelligence system 240) within the grid of a digital free standing insert to a digital coupon that the target user 52 is more likely to be interested in (e.g., based on the preferences of the user 52, as determined through the demonstrated shopping behavior of the user 52, previous usage of related digital coupons, or other sources of such information, as describe above) and/or based on manufacturer preferences (e.g., a prioritization of the corresponding promotional program, as discussed above), the DDACS 50 may increase the likelihood of the user 52 selecting or clipping the corresponding digital coupon for use in a purchase.

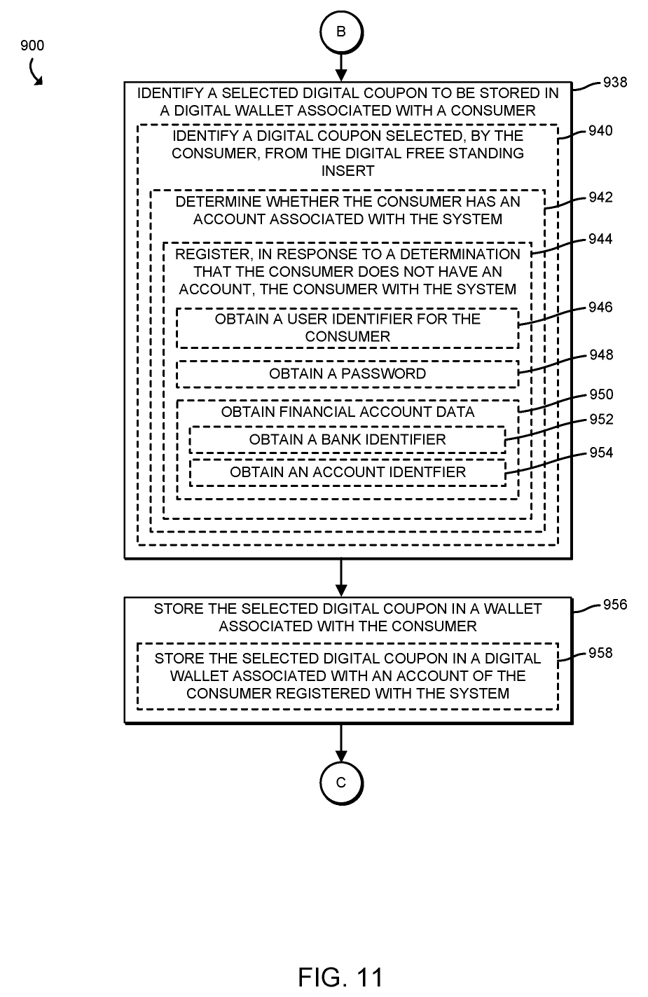

Referring now to FIG. 11, continuing the method 900, the DDACS 50 identifies a selected digital coupon to be stored in a digital wallet associated with a consumer (e.g., the user 52), as indicated in block 938. For example, and as indicated in block 940, the DDACS 50 may identify a digital coupon selected by the consumer (e.g., the user 52) from a digital free standing insert displayed to the user, such as by the user computing device 220. The DDACS 50 may detect the selection through an interaction with the user interface 260 of the user computing device 220 displaying the digital free standing insert and the digital coupons therein. The interaction may be, for example, touching the user interface 260 at the location of a corresponding digital coupon (displayed within an item card) in embodiments in which the user interface 260 includes a touch screen display, or clicking on the location of the digital coupon with a pointing device, such as a mouse.

As described relative to FIGS. 3-5, the DDACS 50 may determine whether the consumer (e.g., the user 52) has an account associated with the DDACS 50, as indicated in block 942. In response to a determination that the consumer (e.g., the user 52) does not have an account associated with the DDACS 50, such as in response to the user 52 selecting the link 430 in the user interface 410 of FIG. 4 to register a new account, the DDACS 50 registers the consumer with the DDACS 50 (e.g., to store an account and a corresponding digital wallet associated with the consumer or user 52 in a database of the back end system 70), as indicated in block 944. In doing so, and as indicated in block 946, the DDACS 50 obtain a user identifier for the consumer (e.g., the user 52). As described above, the user identifier may be a user name, a phone number, an email address, or other identifier unique to the consumer. Further, the DDACS 50 may obtain a password to be associated with the account, as indicated in block 948. As described above relative to FIG. 5, the DDACS 50 may require the user 52 to enter the password multiple times to ensure that the password has not been mistyped and may perform a strength test on the password to ensure that the password satisfies one or more defined rules regarding a required mix of lowercase characters, uppercase characters, numbers, and/or symbols and/or a minimum password length. Further, the DDACS 50 may obtain financial account data associated with the consumer (e.g., the user 52), as indicated in block 950. In doing so, and as indicated in block 952, the DDACS 50 may obtain a bank identifier, which may be embodied as a name, routing number, or other unique identifier of the bank associated with the financial account of the user 52. Additionally, the DDACS 50 may obtain an account identifier for the financial account, as indicated in block 954. The account identifier may be embodied as any identifier, such as a string of numbers, characters, and/or symbols that uniquely identifies the account of the user 52 within a set of financial accounts managed by the bank identified by the bank identifier. The account identifier may be a debit account number, a credit card account number, or the like. As described in connection with FIG. 5, in at least some embodiments, the DDACS 50 may perform validation operations on the financial account data, such as requesting (e.g., via an application programming interface (API) call, a representational state transfer (REST) request, or other mechanism) confirmation, from a computing device 290 of a bank identified by the bank identifier that the corresponding account identifier represents an active account that is managed by that bank. In connection with performing the registration, the DDACS 50 also creates a digital wallet associated with the account of the consumer (e.g., the user 52). The DDACS 50 may create the digital wallet by creating one or more tables or other data structures (e.g., in a memory of the back end system 70) to store digital coupon data associated with digital coupons that the consumer (e.g., the user 52) selected or clipped from one or more digital free standing inserts.

Continuing the method 900 and as indicated in blocks 956, 958, the DDACS 50, stores the selected digital coupon, selected by the consumer (e.g., the user 52) from the displayed digital free standing insert, in a digital wallet associated with the account of the consumer registered with the system (e.g., from the registration process associated with blocks 944, 946, 948, 950, 952, 954 described above).

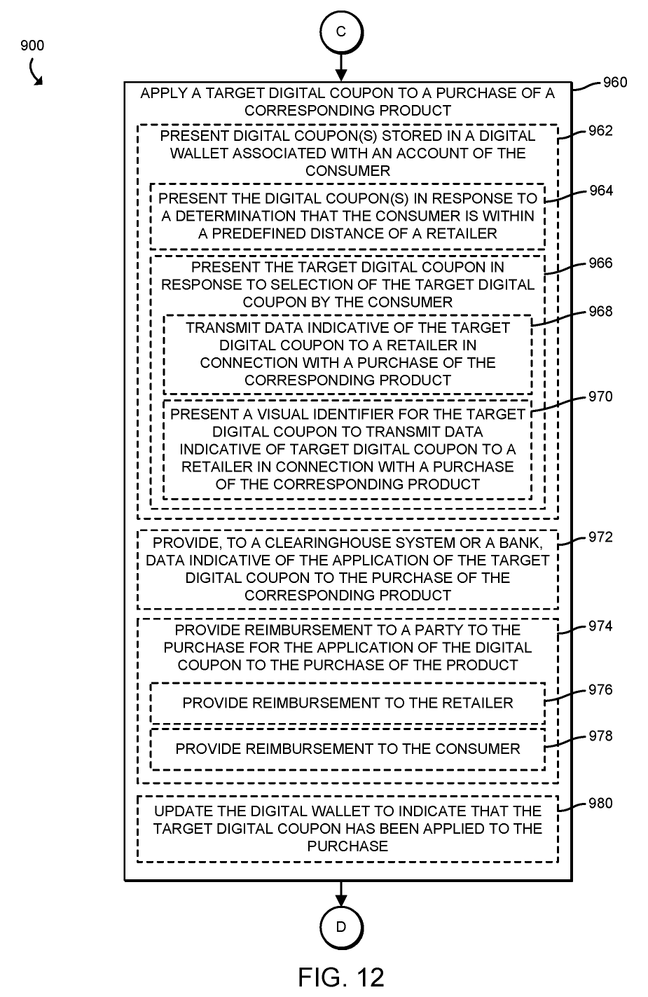

Referring now to FIG. 12, and continuing the method 900, the DDACS 50 may apply a target digital coupon to a purchase of a corresponding product, as indicated in block 960. In doing so, and as indicated in block 962, the DDACS 50 may present one or more digital coupons stored in a digital wallet associated with an account of the consumer. For example, the DDACS 50 (e.g., via the user computing device 220) may display the digital coupons in the digital wallet with a user interface similar to the user interface 610 of FIG. 6. As described relative to FIG. 6, the DDACS 50 (e.g., via the user computing device 220) may present the digital coupon(s) stored in the digital wallet in response to a determination that the consumer is within a predefined distance of a retailer. As indicated in block 966, the DDACS 50 (e.g., the user computing device 220 of the DDACS 50) may present the target digital coupon in response to selection of the target digital coupon by the consumer (e.g., the user 52). For example, the DDACS 50 (e.g., the user computing device 220 of the DDACS 50) may present the target digital coupon in a user interface similar to the user interface 710 of FIG. 7, in which additional details regarding the digital coupon are displayed. In some embodiments, the DDACS 50 (e.g., the user computing device 220 of the DDACS 50) may transmit data indicative of the target digital coupon to a retailer (e.g., to the point of sale computing device 270 of the retailer) in connection with a purchase of the corresponding product, as indicated in block 968. The user computing device 220 may transmit an identifier of the digital coupon visually, such as through a visual identifier that may be optically recognized through a barcode scanner or camera of the point of sale computing device 270, as indicated in block 970. Additionally or alternatively, the user computing device 220 may transmit the identifier of the digital coupon through another mechanism, such as a short range wireless communication protocol (e.g., Bluetooth, NFC, or the like). As describe above, in some embodiments, the user computing device 220 may transmit a combination of the identifier of the digital coupon and an identifier of the consumer (e.g., the user identifier) associated with the digital wallet. As described above, in some embodiments, the user computing device 220 may cycle through multiple digital coupons selected by the user for use in connection with the purchase, such as by pausing momentarily (e.g., for a predefined period of time or until a prompt has been detected to continue) to provide a detailed view of a corresponding selected digital coupon from a set of selected coupons and transmit the corresponding identifier(s) either visually and/or via another method (e.g., a short range wireless communication protocol).

Further, and as indicated in block 972, the DDACS 50 may provide, to a clearinghouse system or a bank, data indicative of the application of the target digital coupon to the purchase of the corresponding product. For example, and as described above, the point of sale computing device 270 may provide a record of the transaction to the clearinghouse computing device 280 and/or may provide the record of the transaction to the back end system 70 to be subsequently requested therefrom by the clearinghouse computing device 280, such as through the settlement integration 90. As indicated in block 974, the DDACS 50 may provide reimbursement to a party to the purchase, for the application of the digital coupon to the purchase of the corresponding product. In doing so, the DDACS 50 may provide reimbursement to the retailer (e.g., by initiating a transfer of funds from a financial account of the manufacturer to a financial account of the retailer), if the retailer bore the cost of the digital coupon(s) at the time of the purchase, as indicated in block 976. Alternatively, the DDACS 50 may provide reimbursement to the consumer (e.g., the user 52) if the consumer applied the digital coupon(s) but still paid an undiscounted price for the correspond product(s) at the time of the purchase, as indicated in block 978. The DDACS 50 may provide the reimbursement via the settlement integration 90 (e.g., through the coordination between the clearinghouse computing device 280 and the bank computing devices 290 described above). Further, the DDACS 50 may update the digital wallet to indicate that the target digital coupon has been applied to the purchase, as indicated in block 980. In doing so, the user computing device 220 may thereafter display that digital coupon with a visual indication that the digital coupon is no longer available to be applied to purchase(s), as described in connection with FIG. 8.

Manufacturing computing device 210 may continuously stream digital coupon data as included in the vendor parameters to dynamic digital advertising content server 230 such that dynamic digital advertising content server 230 may accumulate digital coupon data included in the vendor parameters as stored in dynamic digital advertising server 230. In doing so, dynamic digital advertising content server 330 may continuously accumulate digital coupon data as included in the vendor parameters that are associated with the digital coupons determined by each of the vendors as streamed by manufacturing computing device 210 each time a user selects a digital. The digital coupon data included in the vendor parameters is accumulated from the selections of digital coupons by each of the users and analyzed to recognize different vendor parameters associated with the user selections of the digital coupons that are depicted by each digital coupon circular. Over time as the digital coupon data as included in the vendor parameters is accumulated by dynamic digital advertising content server 230 continues to increase, artificial intelligence system 240 may then apply a neural network algorithm such as but not limited to a multilayer perceptron (MLP), a restricted Boltzmann Machine (RBM), a convolution neural network (CNN), and/or any other neural network algorithm that will be apparent to those skilled in the relevant art(s) without departing from the spirit and scope of the disclosure.

Each time that digital coupon data as included in the vendor parameters is streamed to dynamic digital advertising content server 230, artificial intelligence system 240 may then assist manufacturing computing device 210 by providing manufacturing computing device 210 with the appropriate recognition of the item cards depicted by the digital coupon circular to automatically adjust the display of the item cards by the manufacturing computing device 210 to automatically display the digital coupons via each corresponding item card based on the user preferences and/or vendor preferences. Artificial intelligence system 240 may assist manufacturing computing device 210 in learning as to the appropriate item card depicted by the digital coupon circular image based on the digital coupon data included in the vendor parameters such that the artificial intelligence system 240 may further improve the automatic adjusting of the display of the item cards by manufacturing computing device 210 in automatically recognizing the appropriate item cards and positioning of the item cards based on the user preferences and/or vendor preferences to further enhance the selection of digital coupons by the user as requested by the vendor. Artificial intelligence system 240 may provide the manufacturing computing device 210 with improved accuracy in automatically adjusting the display of the item cards such that artificial intelligence system 240 may continue to learn upon with the accumulation of digital coupon data included in the vendor parameters that is provided by manufacturing computing device 210 and/or any computing device associated with dynamic retail media network system to the digital dynamic advertising content server 230. Thus, automatic adjustment of the display of item cards by manufacturing computing device 210 may further enhance the automatic display of item cards associated with digital coupons.

While the invention has been illustrated and described in detail in the drawings and foregoing description, the same is to be considered as illustrative and not restrictive in character, it being understood that only the preferred embodiments have been shown and described and that all changes and modifications that come within the spirit of the inventions are desired to be protected. It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

### Conclusion

In one form of the instant disclosure, a dynamic digital advertising content communications system (DDACS) 50 for facilitating dynamic presentation, organization, and application of digital coupons associated with a digital free standing insert associated with a manufacturer of corresponding products includes at least one processor and a memory coupled with the processor. The memory includes instructions that when executed by the processor cause the processor to display, from a set of digital coupon data, a set of one or more digital coupons that are redeemable at multiple different retailer networks to obtain a discount on one or more corresponding products, wherein the display is formatted as a digital free standing insert 330 that includes a grid 332 of item cards 340, 342, 344, 346, 348, 350, 352, wherein each item card is associated with a corresponding digital coupon 360, 362, 364, 366, 368, 370, 372 and in which at least one of a size or a position of each item card 340, 342, 344, 346, 348, 350, 352 is determined as a function of one or more vendor parameters. The instructions may additionally cause the processor to identify, from the set of one or more displayed digital coupons 360, 362, 364, 366, 368, 370, 372 from the digital free standing insert 330, a selected digital coupon to be stored in a digital wallet associated with a consumer, wherein the selected digital coupon is selected based on detection of user input indicative of a selection by the consumer of the selected digital coupon from the displayed digital coupons in the digital free standing insert 330; store, in response to identification of the selected digital coupon and in response to a determination that a consumer account of the consumer has been registered in association with the DDACS 50, data indicative of the selected digital coupon in the digital wallet; present a set of one or more stored digital coupons 620, 622, 624, 626, 628, 630, including the selected digital coupon, stored in association with the digital wallet of the consumer, available to be applied in connection with a purchase of a corresponding product from a retailer of the multiple different retailer networks; and facilitate application of a target digital coupon 620 from the presented set of one or more stored digital coupons 620, 622, 624, 626, 628, 630 to the purchase of the corresponding product in response to a selection, by the consumer, of the target digital coupon 620 from the presented set of one or more stored digital coupons 620, 622, 624, 626, 628, 630.

In at least some embodiments, the processor of the DDACS 50 is further configured to display the set of one or more digital coupons 360, 362, 364, 366, 368, 370, 372 formatted as the digital free standing insert 330 in response to a determination that the consumer has selected, through an interaction with a dynamic digital advertising content communications device 220, a digital advertisement displayed by the dynamic digital advertising content communications device 220, wherein the digital advertisement has a link to a network accessible address of the set of one or more digital coupons formatted as the digital free standing insert 330.

In some embodiments, the processor of the DDACS 50 is further configured to facilitate application of the target digital coupon 620 to the purchase of the corresponding product by presenting a visual identifier 722 to transmit data indicative of the target digital coupon 620 to a retailer in connection with the purchase of the corresponding product, wherein the visual identifier is a bar code or a quick response code.

In yet further embodiments, the processor of the DDACS 50 may be further configured to present the set of one or more digital coupons stored in association with the digital wallet of the consumer in response to a determination, by the dynamic digital advertising content communications device 220 of the DDACS 50 and based on a signal from at least one of a global positioning system, a cellular communications network, a radio frequency identification tag, or a short range communications system, that the dynamic digital advertising content communications device 220 is within a predefined distance of the retailer.

In some embodiments, the processor of the DDACS 50 is further configured to determine, in response to identifying the selected digital coupon, whether the consumer account of the consumer has been registered in association with the DDACS 50. Additionally, the processor may be configured to register, in response to a determination that the consumer account has not been registered, the consumer account with the DDACS 50, including obtaining a user identifier for the consumer.

In yet further embodiments, the processor of the DDACS 50 is configured to obtain, a password and financial account data that includes a bank identifier and an account identifier to register the consumer account with the DDACS 50.

Additionally, in at least some embodiments, the processor of the DDACS 50 is further configured to display, from the set of digital coupon data and in the digital free standing insert 330, the set of one or more digital coupons 360, 362, 364, 366, 368, 370, 372 that are distributed as a function of a set of one or more distribution parameters that are based on a demonstrated shopping behavior of the consumer, one or more manufacturer preferences, and timing parameters defined for each digital coupon in the digital coupon data.

In some embodiments, the processor of the DDACS 50 is further configured to display, from the set of digital coupon data and in the digital free standing insert 330, the set of one or more digital coupons 360, 362, 364, 366, 368, 370, 372 that are distributed further as a function of one or more artificial intelligence models.

In some embodiments, the processor of the DDACS 50 is further configured to update, after application of the target digital coupon 620 to the purchase, a display of the digital wallet to indicate that the target digital coupon 720 has been applied to the purchase.

The processor of the DDACS 50, in some embodiments, may be configured to facilitate application of the target digital coupon 620 from the presented set of one or more stored digital coupons 620, 622, 624, 626, 628, 630 to the purchase of the corresponding product by facilitating provision, to a clearing house system 280 or a bank 290, data indicative of the application of the target digital coupon 620 to the purchase of the corresponding product.

In some embodiments, the processor of the DDACS 50 is configured to facilitate application of the target digital coupon 620 from the presented set of one or more stored digital coupons 620, 622, 624, 626, 628, 630 to the purchase of the corresponding product by facilitating provision, to the retailer or the customer, reimbursement of a monetary value of the discount associated with the target digital coupon 620.

It is to be appreciated that the Detailed Description section, and not the Abstract section, is intended to be used to interpret the claims. The Abstract section may set forth one or more, but not all exemplary embodiments, of the present disclosure, and thus, is not intended to limit the present disclosure and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries may be defined so long as the specified functions and relationships thereof are appropriately performed.

It will be apparent to those skilled in the relevant art(s) the various changes in form and detail can be made without departing from the spirt and scope of the present disclosure. Thus the present disclosure should not be limited by any of the above-described exemplary embodiments, but should be defined only in accordance with the following claims and their equivalents.

What is claimed is:

1. A dynamic retail media network system for generating a digital coupon circular displayed to a user via a communications device based on a plurality of vendor parameters that dynamically trigger a generation and display of a plurality of circular content items included in the digital coupon circular associated with a plurality of retailers, comprising:
at least one processor; and
a memory coupled with the at least one processor, the memory including instructions that when executed by the at least one processor cause the at least one processor to:
provide access to a digital media coupon platform associated with the plurality of retailers in response to an end user selection of a digital coupon of a plurality of digital coupons, each digital coupon of the plurality of coupons being associated with each corresponding retailer and a different vendor of a plurality of vendors that vend with the retailer,
trigger the vendor parameters associated with a vendor of the selected digital coupon to determine a position of each item card of a plurality of item cards to be displayed in the digital coupon circular associated with each corresponding retailer based on the vendor parameters associated with the vendor of the selected digital coupon, wherein the vendor parameters associated with the vendor of the selected digital coupon are indicative of a presentation of each item card as displayed in the digital coupon circular associated with each corresponding retailer and are based on a vendor priority to display the selected item card associated with the vendor of the selected digital coupon as compared to item cards not associated with the vendor of the selected digital coupon,
dynamically generate the digital coupon circular associated with each retailer that includes the item cards created based on the vendor parameters associated with the vendor of the selected digital coupon that displays in real-time the selected item card based on the display request of the vendor of the selected digital coupon, wherein the selected item card is displayed in real-time based on the display request of the vendor of the selected digital coupon as compared to the item cards not associated with the vendor of the selected digital coupon based on a current state of the vendor parameters,
dynamically receive updates to the vendor parameters associated with each corresponding item card that are updated in real-time based on the selections by the vendor of different item cards in the digital circular to continuously identify product preferences of the vendor, wherein each item card changes as the corresponding vendor parameters associated with each item card change;
dynamically adjust the digital circular coupon grid as formatted on a display of the communications device to dynamically display updates to each item card included in the digital circular coupon grid to update an item card position and item card size of each item card and integrating the updated vendor parameters as triggered by the selections by the vendor to continuously identify product preferences of the vendor thereby triggering a change to the item card content displayed and a change in size and spatial position as each item card in the digital circular is updated; and
dynamically adjust the digital circular coupon grid as formatted on the display of the communications device to prioritize the display of the selected item card in the digital coupon circular based on the updated vendor parameters, wherein the size and spatial position of each item card is dynamically formatted to be displayed based on the content of each item card after the selected item card is dynamically formatted to be displayed based on the updated vendor parameters thereby displaying the selected item card based on the display request of the vendor of the selected digital coupon as compared to item cards not associated with the vendor of the selected digital coupon as triggered by the selections by the vendor to continuously identify the product preferences of the vendor.

2. The dynamic retail media network system of claim 1, wherein the processor is further configured to:
instruct the communications device display to dynamically adjust the display to display updates to a digital circular coupon grid that displays each item card based on updates to a rearrangement of each item card due to a change in selection of the digital coupon received from the end user, wherein a spatial position of each item card as displayed is dynamically adjusted as a plurality of vendor parameters associated with the change in selection of the digital coupon are updated thereby triggering the rearrangement of each item card.

3. The dynamic retail media network system of claim 1, wherein the processor is further configured to:
receive from the end user a first selection of a first digital coupon associated with a first vendor that is displayed on the digital media platform associated with each corresponding retailer with a second digital coupon associated with a second vendor displayed on the digital media coupon platform associated with each corresponding retailer;
trigger a first set of vendor parameters associated with the first vendor of the selected digital coupon to determine the position of a first item card associated with the selected first digital coupon of the first vendor to be displayed in the digital coupon circular associated with each corresponding retailer based on the first set of vendor parameters associated with the first vendor, wherein the first set of vendor parameters associated with the first vendor of the selected first digital retailer are indicative of a presentation of the first item card as displayed in the digital coupon circular of each corresponding retailer based on a first vendor priority of the first vendor to display the first item card as compared to a display of the second item card not included in the selected first digital coupon;
generate the digital coupon circular that includes the first item card positioned based on the first vendor parameters associated with the first vendor of the selected first digital coupon that displays the first item card based on the display request of the first vendor of the first selected digital coupon and includes the second item card positioned in a secondary position as compared to the first item card, wherein the secondary position of the second item card is determined after the first item card is positioned based on the first vendor parameters; and
instruct the communications device to dynamically display the first item card in a first item card position and a first item card size to prioritize the display of the first item card as compared to the second item card that is displayed in a secondary item card position and a secondary item card size to be secondary to the first item card position and the first item card size of the first item card.

4. The dynamic retail media network system of claim 3, wherein the processor is further configured to:
receive from the end user a second selection of a second digital coupon associated with the second vendor that is displayed on the digital media platform associated with the retailer with the first digital coupon associated with the first vendor displayed on the digital media platform associated with each corresponding retailer;
trigger a second set of vendor parameters associated with the second vendor of the selected digital coupon to determine the position of the second item card associated with the selected second digital coupon of the second vendor to be displayed in the digital coupon circular associated with the second set of vendor parameters associated with the second vendor, wherein the second set of vendor parameters associated with the second vendor of the selected second coupon are indicative of a presentation of the second item card as displayed in the digital coupon circular based on a second vendor priority of the second vendor to display the second item card as compared to the display of the first item card included in the first coupon;
rearrange the positioning of the second item card and the first item card based on the second vendor parameters associated with the second vendor of the selected second digital coupon based on the display request of the second vendor of the second selected digital coupon and includes the first item card positioned in the secondary position as compared to the second item card, wherein the second item card replaces the position of the first item card and moves the first item card to the secondary position; and
instruct the communications device to dynamically display the second item card in the first item card position and the first item card size to prioritize the display of the second item card as compared to the first item card that is displayed in secondary position.

5. The dynamic retail media network system of claim 4, wherein the processor is further configured to:
monitor each end user from a plurality of end users that selects the first digital coupon associated with the first vendor that is displayed on the digital media platform associated with the retailer via a corresponding communications device of each end user;
track each end user as each end user navigates the digital coupon circular to determine whether each end user selects the first item card positioned in the digital coupon circular based on the first vendor position provided by the first set of vendor parameters;
determine each end user that purchases a first product as advertised in the first digital coupon and displayed in the first item card of the digital coupon circular based on selecting the first digital coupon advertising the first product and selecting the first item card of the digital coupon circular displaying the first product; and
provide to the first vendor a quantity of end users that purchases the first product as advertised in the first digital coupon and displayed in the first item card of the digital coupon circular based on selecting the first digital coupon advertising the first product and selecting the first item card of the digital coupon circular displaying the first product.

6. The dynamic retail media network system of claim 5, wherein the processor is further configured to:
monitor each end user from the plurality of end users that selects the first digital coupon associated with the first vendor that is displayed on the digital media platform associated with each corresponding retailer via the corresponding communications device of each end user;
track each end user that navigates the digital coupon circular to determine whether each end user selects the second item card positioned in the secondary position of the digital coupon circular as compared to the first item card positioned in the digital coupon circular based on the first vendor potion provided by the first set of vendor parameters;
determine each end user that purchases a second product as advertised as displayed in the second item card in the secondary position of the digital coupon circular based on selecting the first digital coupon advertising the first product and selecting the second item card of the digital circular displaying the second product in the secondary position; and
providing to the second vendor a quantity of end users that purchase the second product as displayed in the second item card in the secondary position of the digital coupon circular based on selecting the first digital coupon advertising the first product and selecting the second item card of the digital circular displayed in the secondary position as compared to the first product.

7. The dynamic retail media network system of claim 2, wherein the processor is further configured to:
generate the digital coupon circular that includes an item card position and an item card size associated with each item card partition that each item card is to be displayed based on the vendor parameters associated with the vendor of the selected digital coupon, wherein the selected item card that corresponds to the selected digital coupon is displayed in the item card position and the item card size that corresponds with the display request of the vendor of the selected digital coupon as compared to the item cards not associated with the vendor of the selected digital coupon.

8. The dynamic retail media network system of claim 7, wherein the processor is further configured to:
instruct the communications device to dynamically display each item card in an item card position and an item card size associated with each item card partition to prioritize the display of the selected item card in the digital coupon circular of the retailer based on the vendor parameters, wherein the selected item card is dynamically formatted with item card content to dynamically display the selected item card with the item card content as spatially positioned in a digital coupon circular grid to prioritize the display of the item card content of the selected item card based on the vendor parameters.

9. The dynamic retail media network system of claim 8, wherein the processor is further configured to:
dynamically receive updates to the digital coupon circular as each item card included in the digital coupon circular are updated based on the corresponding vendor parameters associated with each corresponding selected digital coupon in real-time, wherein each item card changes as the corresponding vendor parameters associated with each corresponding selected digital coupon change; and
dynamically instruct the communications device to display each updated item card included in the digital coupon circular in real-time as the corresponding vendor parameters associated with each corresponding selected digital coupon change in real-time.

10. The dynamic retail media network system of claim 9, wherein the processor is further configured to:
dynamically receive updates to the digital coupon circular as a size associated with each item card in the digital coupon circular is adjusted based on the corresponding vendor parameters associated with each corresponding selected digital coupon are updated in real-time thereby triggering a change in size associated with each item card as the corresponding vendor parameters associated with each selected digital coupon change; and
dynamically instruct the communications device to display each updated size of each updated item card included in the digital coupon circular in real-time as the corresponding vendor parameters associated with each selected digital coupon are updated in real-time triggering a change in size associated with each item card.

11. A dynamic retail media network method for generating a digital coupon circular displayed to a user via a communications device based on a plurality of vendor parameters that dynamically trigger a generation and display of a plurality of circular content items included in the digital coupon circular associated with a plurality of retailers, comprising:
providing access to a digital media coupon platform associated with the plurality of retailers in response to an end user selection of a digital coupon of a plurality of digital coupons, each digital coupon of the plurality of coupons being associated with each corresponding retailer and a different vendor of a plurality of vendors that vend with the retailer,
triggering the vendor parameters associated with a vendor of the selected digital coupon to determine a position of each item card of a plurality of item cards to be displayed in the digital coupon circular associated with each corresponding retailer based on the vendor parameters associated with the vendor of the selected digital coupon, wherein the vendor parameters associated with the vendor of the selected digital coupon are indicative of a presentation of each item card as displayed in the digital coupon circular associated with each corresponding retailer and are based on a vendor priority to display the selected item card associated with the vendor of the selected digital coupon as compared to item cards not associated with the vendor of the selected digital coupon,
dynamically generating the digital coupon circular associated with each retailer that includes the item cards created based on the vendor parameters associated with the vendor of the selected digital coupon that displays in real-time the selected item card based on the display request of the vendor of the selected digital coupon, wherein the selected item card is displayed in real-time based on the display request of the vendor of the selected digital coupon as compared to the item cards not associated with the vendor of the selected digital coupon based on a current state of the vendor parameters,
dynamically receiving updates to the vendor parameters associated with each corresponding item card that are updated in real-time based on the selections by the vendor of different item cards in the digital circular to continuously identify product preferences of the vendor, wherein each item card changes as the corresponding vendor parameters associated with each item card change;
dynamically adjusting the digital circular coupon grid as formatted on a display of the communications device to dynamically display updates to each item card included in the digital circular coupon grid to update an item card position and item card size of each item card and integrating the updated vendor parameters as triggered by the selections by the vendor to continuously identify product preferences of the vendor thereby triggering a change to the item card content displayed and a change in size and spatial position as each item card in the digital circular is updated; and
dynamically adjusting the digital circular coupon grid as formatted on the display of the communications device to prioritize the display of the selected item card in the digital coupon circular based on the updated vendor parameters, wherein the size and spatial position of each item card is dynamically formatted to be displayed based on the content of each item card after the selected item card is dynamically formatted to be displayed based on the updated vendor parameters thereby displaying the selected item card based on the display request of the vendor of the selected digital coupon as compared to item cards not associated with the vendor of the selected digital coupon as triggered by the selections by the vendor to continuously identify the product preferences of the vendor.

12. The dynamic retail media network method of claim 11, wherein the wherein the instructing the communications device, comprises:
instruct the communications device display to dynamically adjust the display to display updates to a digital circular coupon grid that displays each item card based on updates to a rearrangement of each item card due to a change in selection of the digital coupon received from the end user, wherein a spatial position of each item card as displayed is dynamically adjusted as a plurality of vendor parameters associated with the change in selection of the digital coupon are updated thereby triggering the rearrangement of each item card.

13. The dynamic retail media network method of claim 11, further comprising:
receiving from the end user a first selection of a first digital coupon associated with a first vendor that is displayed on the digital media platform associated with each corresponding retailer with a second digital coupon associated with a second vendor displayed on the digital media coupon platform associated with each corresponding retailer;
triggering a first set of vendor parameters associated with the first vendor of the selected digital coupon to determine the position of a first item card associated with the selected first digital coupon of the first vendor to be displayed in the digital coupon circular associated with each corresponding retailer based on the first set of vendor parameters associated with the first vendor, wherein the first set of vendor parameters associated with the first vendor of the selected first digital retailer are indicative of a presentation of the first item card as displayed in the digital coupon circular of each corresponding retailer based on a first vendor priority of the first vendor to display the first item card as compared to a display of the second item card not included in the selected first digital coupon;
generating the digital coupon circular that includes the first item card positioned based on the first vendor parameters associated with the first vendor of the selected first digital coupon that displays the first item card based on the display request of the first vendor of the first selected digital coupon and includes the second item card positioned in a secondary position as compared to the first item card, wherein the secondary position of the second item card is determined after the first item card is positioned based on the first vendor parameters; and
instructing the communications device to dynamically display the first item card in a first item card position and a first item card size to prioritize the display of the first item card as compared to the second item card that is displayed in a secondary item card position and a secondary item card size to be secondary to the first item card position and the first item card size of the first item card.

14. The dynamic retail media method system of claim 13, further comprising:
receiving from the end user a second selection of a second digital coupon associated with the second vendor that is displayed on the digital media platform associated with the retailer with the first digital coupon associated with the first vendor displayed on the digital media platform associated with each corresponding retailer;
triggering a second set of vendor parameters associated with the second vendor of the selected digital coupon to determine the position of the second item card associated with the selected second digital coupon of the second vendor to be displayed in the digital coupon circular associated with the second set of vendor parameters associated with the second vendor, wherein the second set of vendor parameters associated with the second vendor of the selected second coupon are indicative of a presentation of the second item card as displayed in the digital coupon circular based on a second vendor priority of the second vendor to display the second item card as compared to the display of the first item card included in the first coupon;
rearranging the positioning of the second item card and the first item card based on the second vendor parameters associated with the second vendor of the selected second digital coupon based on the display request of the second vendor of the second selected digital coupon and includes the first item card positioned in the secondary position as compared to the second item card, wherein the second item card replaces the position of the first item card and moves the first item card to the secondary position; and
instructing the communications device to dynamically display the second item card in the first item card position and the first item card size to prioritize the display of the second item card as compared to the first item card that is displayed in secondary position.

15. The dynamic retail media network method of claim 14, further comprising:
monitoring each end user from a plurality of end users that selects the first digital coupon associated with the first vendor that is displayed on the digital media platform associated with the retailer via a corresponding communications device of each end user;
tracking each end user as each end user navigates the digital coupon circular to determine whether each end user selects the first item card positioned in the digital coupon circular based on the first vendor position provided by the first set of vendor parameters;
determining each end user that purchases a first product as advertised in the first digital coupon and displayed in the first item card of the digital coupon circular based on selecting the first digital coupon advertising the first product and selecting the first item card of the digital coupon circular displaying the first product; and
providing to the first vendor a quantity of end users that purchases the first product as advertised in the first digital coupon and displayed in the first item card of the digital coupon circular based on selecting the first digital coupon advertising the first product and selecting the first item card of the digital coupon circular displaying the first product.

16. The dynamic retail media network method of claim 15, further comprising:
monitoring each end user from the plurality of end users that selects the first digital coupon associated with the first vendor that is displayed on the digital media platform associated with each corresponding retailer via the corresponding communications device of each end user;
tracking each end user that navigates the digital coupon circular to determine whether each end user selects the second item card positioned in the secondary position of the digital coupon circular as compared to the first item card positioned in the digital coupon circular based on the first vendor potion provided by the first set of vendor parameters;
determining each end user that purchases a second product as advertised as displayed in the second item card in the secondary position of the digital coupon circular based on selecting the first digital coupon advertising the first product and selecting the second item card of the digital circular displaying the second product in the secondary position; and
providing to the second vendor a quantity of end users that purchase the second product as displayed in the second item card in the secondary position of the digital coupon circular based on selecting the first digital coupon advertising the first product and selecting the second item card of the digital circular displayed in the secondary position as compared to the first product.

17. The dynamic retail media network method of claim 12, further comprising:
generating the digital coupon circular that includes an item card position and an item card size associated with each item card partition that each item card is to be displayed based on the vendor parameters associated with the vendor of the selected digital coupon, wherein the selected item card that corresponds to the selected digital coupon is displayed in the item card position and the item card size that corresponds with the display request of the vendor of the selected digital coupon as compared to the item cards not associated with the vendor of the selected digital coupon.

18. The dynamic retail media network method of claim 17, further comprising:
instructing the communications device to dynamically display each item card in an item card position and an item card size associated with each item card partition to prioritize the display of the selected item card in the digital coupon circular of the retailer based on the vendor parameters, wherein the selected item card is dynamically formatted with item card content to dynamically display the selected item card with the item card content as spatially positioned in a digital coupon circular grid to prioritize the display of the item card content of the selected item card based on the vendor parameters.

19. The dynamic retail media network method of claim 18, further comprising:
dynamically receiving updates to the digital coupon circular as each item card included in the digital coupon circular are updated based on the corresponding vendor parameters associated with each corresponding selected digital coupon in real-time, wherein each item card changes as the corresponding vendor parameters associated with each corresponding selected digital coupon change; and
dynamically instructing the communications device to display each updated item card included in the digital coupon circular in real-time as the corresponding vendor parameters associated with each corresponding selected digital coupon change in real-time.

20. The dynamic retail media network method of claim 19, further comprising:
dynamically receiving updates to the digital coupon circular as a size associated with each item card in the digital coupon circular is adjusted based on the corresponding vendor parameters associated with each corresponding selected digital coupon are updated in real-time thereby triggering a change in size associated with each item card as the corresponding vendor parameters associated with each selected digital coupon change; and
dynamically instructing the communications device to display each updated size of each updated item card included in the digital coupon circular in real-time as the corresponding vendor parameters associated with each selected digital coupon are updated in real-time triggering a change in size associated with each item card.
